(19) United States
(12) Patent Application Publication
(10) Pub. No.: US 2026/0023466 A1
(43) Pub. Date: Jan. 22, 2026

(54) INTELLIGENT USER INTERFACE ROTATION

(71) Applicant: Google LLC, Mountain View, CA (US)

(72) Inventor: Michael Alexander Digman, Mountain View, CA (US)

(21) Appl. No.: 18/869,618

(22) PCT Filed: Jun. 6, 2022
(86) PCT No.: PCT/US2022/072776

§ 371 Date: Nov. 26, 2024

(51) Int. Cl. G06F 3/04845; G06F 1/16

(52) U.S. Cl. CPC G06F 3/04845; G06F 1/1694; G06F 2200/1614

(57) ABSTRACT

A computing device may activate an application that is operable to output a user interface in a second interface orientation and is not operable to output the user interface in a first interface orientation. The computing device may determine, for the application, a re-oriented user interface in the first interface orientation. The computing device may output the re-oriented user interface for display at the display device in the first interface orientation.

### BACKGROUND

A mobile computing device that includes a display may use sensor data generated from motion sensors to determine the orientation of the display of the mobile computing device. The mobile computing device may perform autorotation of the user interface outputted by the mobile computing device so that the mobile computing device may, in response to determining a change in the orientation of the display of the mobile computing device, change the orientation of the user interface outputted by the mobile computing device to correspond to the orientation of the display.

### SUMMARY

In general, the techniques of this disclosure are directed to determining the interface orientations of user interfaces to be outputted by a computing device for display at a display device when the display device is locked to a specific interface orientation. A computing device may lock a display device to a specific orientation. When a computing device activates, as the foreground application, an application that is not operable to output a user interface in the specific orientation to which the display device is locked, the computing device may be able to determine a re-oriented user interface for the application in the specific orientation to which the display device is locked. The computing device may therefore output the re-oriented user interface for display at the display device in the specific orientation to which the display device is locked.

In some aspects, the techniques described herein relate to a method including: activating, by one or more processors, an application that is operable to output a user interface in a second interface orientation and is not operable to output the user interface in a first interface orientation; determining, by the one or more processors and for the application, a re-oriented user interface in the first interface orientation; and outputting, by the one or more processors, the re-oriented user interface for display at a display device in the first interface orientation.

In some aspects, the techniques described herein relate to a computing device including: a memory storing instructions; and one or more processors that execute the instructions to: activate an application that is operable to output a user interface in a second interface orientation and is not operable to output the user interface in a first interface orientation; determine a re-oriented user interface for the application in the first interface orientation; and output the re-oriented user interface for display at a display device in the first interface orientation

In some aspects, the techniques described herein relate to a non-transitory computer-readable storage medium including instructions, that when executed by one or more processors, cause the one or more processors of a computing device to: activate an application that is operable to output a user interface in a second interface orientation and is not operable to output the user interface in a first interface orientation; determine, for the application, a re-oriented user interface in the first interface orientation; and output the re-oriented user interface for display at a display device in the first interface orientation.

In some aspects, the techniques described herein relate to an apparatus that includes: means for activating an application that is operable to output a user interface in a second interface orientation and is not operable to output the user interface in a first interface orientation; means for determining a re-oriented user interface for the application in the first interface orientation; and means for outputting the re-oriented user interface for display at a display device in the first interface orientation.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIGS. 1A-1C are conceptual diagrams illustrating a computing device that performs adaptive user interface rotation, in accordance with one or more aspects of the present disclosure.

FIG. 2 is a block diagram illustrating further details of an example computing device, in accordance with one or more aspects of the present disclosure.

FIG. 3 is a conceptual diagram illustrating another example of a computing device that performs adaptive user interface rotation, in accordance with one or more aspects of the present disclosure.

FIG. 4 is a conceptual diagram illustrating another example of a computing device that performs adaptive user interface rotation, in accordance with one or more aspects of the present disclosure.

FIG. 5 is a conceptual diagram illustrating another example of a computing device that performs adaptive user interface rotation, in accordance with one or more aspects of the present disclosure.

FIG. 6 is a conceptual diagram illustrating another example of a computing device that performs adaptive user interface rotation, in accordance with one or more aspects of the present disclosure.

FIG. 7 is a conceptual diagram illustrating another example of a computing device that performs adaptive user interface rotation, in accordance with one or more aspects of the present disclosure.

FIG. 8 is a flowchart illustrating example operations performed by an example computing device, in accordance with one or more aspects of the present disclosure.

### DETAILED DESCRIPTION

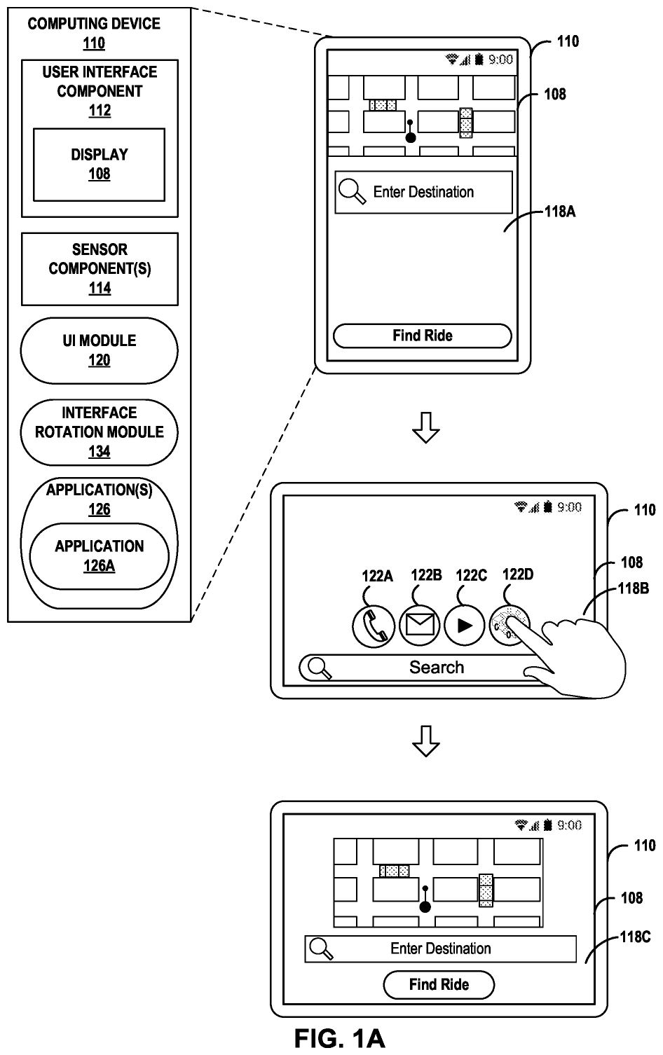

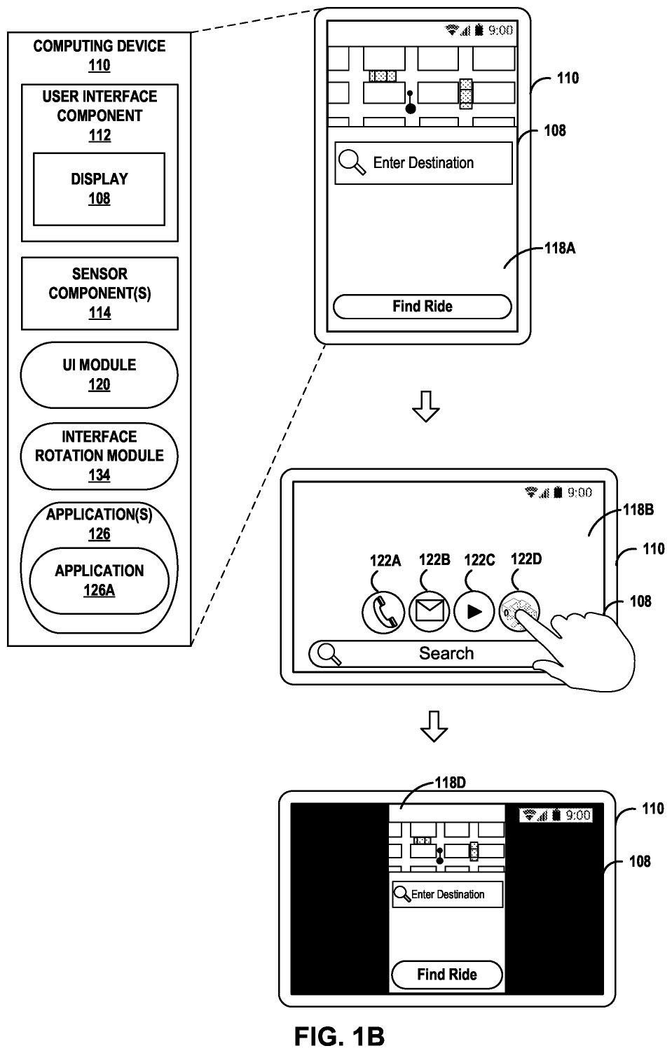

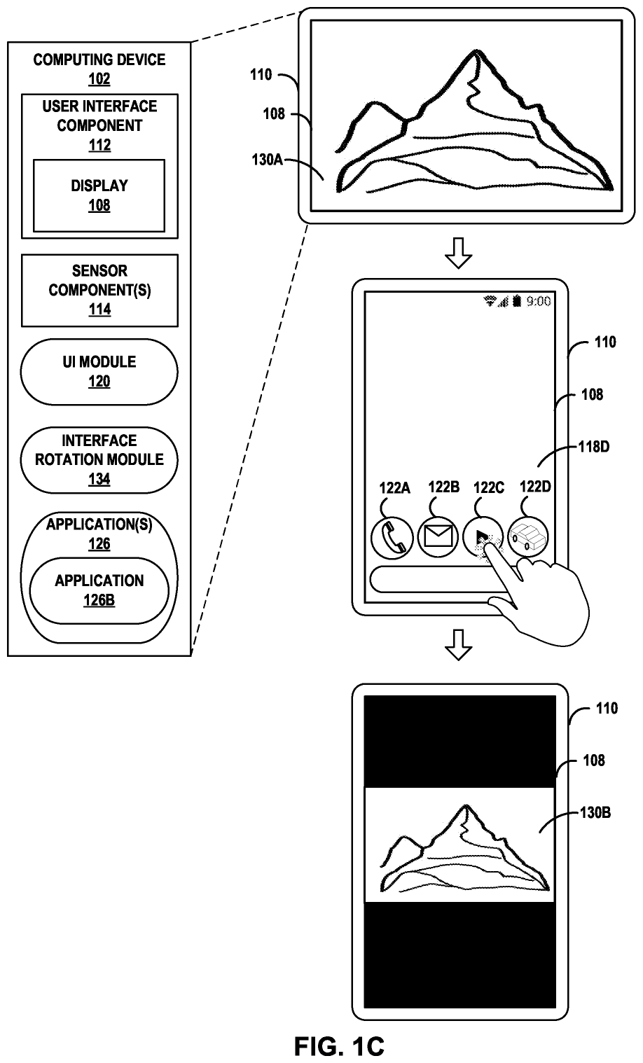

FIGS. 1A-1C are conceptual diagrams illustrating a computing device that performs adaptive user interface rotation, in accordance with one or more aspects of the present disclosure. In the example of FIG. 1A, computing device 110 may represent a mobile or non-mobile computing device. Examples of computing device 110 include a mobile phone, a tablet computer, a laptop computer, a wearable device (e.g., a computerized watch, computerized glasses, etc.), a personal digital assistant (PDA), a media player, an e-book reader, or any other type of mobile, non-mobile, wearable, and non-wearable computing device.

Computing device 110 includes user interface component (“UIC”) 112, one or more sensor components 114, user interface (“UI”) module 120, interface rotation module 134, and one or more applications 126.

UIC 112 of computing device 110 may function as an input and/or output device for computing device 110. UIC 112 may be implemented using various technologies. For instance, UIC 112 may function as an input device using a resistive touchscreen, a surface acoustic wave touchscreen, a capacitive touchscreen, a projective capacitance touchscreen, a pressure sensitive screen, an acoustic pulse recognition touchscreen, or another presence-sensitive screen technology. UIC 102 includes display 108 that may function as an output device using any one or more of a liquid crystal display (LCD), dot matrix display, light emitting diode (LED) display, microLED, organic light-emitting diode (OLED) display, e-ink, or similar monochrome or color display capable of outputting visible information to the user of computing device 110.

Display 108 included in UIC 112 of computing device 110 may be a presence-sensitive screen that may receive tactile user input from a user of computing device 110. UIC 112 may receive the tactile user input by detecting one or more taps and/or gestures from a user of computing device 110 (e.g., the user touching or pointing to one or more locations of display 108 with a finger or a stylus pen). Display 108 may present output, such as a user interface, which may be related to functionality provided by computing device 110. For example, display 108 may present various functions and applications executing on computing device 110 such as an electronic message application, a messaging application, a map application, etc.

One or more applications 126 may include functionality to perform any variety of operations on computing device 110. For instance, one or more applications 126 may include an email application, text messaging application, instant messaging application, weather application, video conferencing application, social networking application, weather application, stock market application, emergency alert application, sports application, office productivity application, ride sharing application, multimedia player, etc.

Although shown as operable by computing device 110, one or more applications 126 may, in some examples, be operable by a remote computing device that is communicatively coupled to computing device 110. In such examples, an application executing at a remote computing device may cause the remote computing device to send the content and intent information using any suitable form of data communication (e.g., wired or wireless network, short-range wireless communication such as Near Field Communication or Bluetooth, etc.). In some examples, a remote computing device may be a computing device that is separate from computing device 110. For instance, the remote computing device may be operatively coupled to computing device 110 by a network. Examples of a remote computing device may include, but is not limited to a server, smartphone, tablet computing device, smart watch, and desktop computer. In some examples, a remote computing device may not be an integrated component of computing device 110.

UI module 120 may interpret inputs detected at UIC 112 (e.g., as a user provides one or more gestures at a location of display 108 at which a user interface is displayed). UI module 120 may relay information about the inputs detected at UIC 112 to one or more associated platforms, operating systems, applications, and/or services executing at computing device 110 to cause computing device 110 to perform a function. UI module 120 may also receive information and instructions from one or more associated platforms, operating systems, applications, and/or services executing at computing device 110 (e.g., one or more applications 126) for generating a GUI. In addition, UI module 120 may act as an intermediary between the one or more associated platforms, operating systems, applications, and/or services executing at computing device 110 and various output devices of computing device 110 (e.g., speakers, LED indicators, vibrators, etc.) to produce output (e.g., graphical, audible, tactile, etc.) with computing device 110.

UI module 120 may be implemented in various ways. For example, UI module 120 may be implemented as a downloadable or pre-installed application or “app.” In another example, UI module 120 may be implemented as part of a hardware unit of computing device 110. In another example, UI module 120 may be implemented as part of an operating system of computing device 110. In some instances, portions of the functionality of UI module 120 or any other module described in this disclosure may be implemented across any combination of an application, hardware unit, and operating system.

Interface rotation module 134 may re-orient user interfaces outputted by one or more applications 126. That is, interface rotation module 134 may receive a user interface that is outputted by an application in a first interface orientation and may determine, based on the interface, a re-oriented user interface for the application in a second interface orientation different from the first interface orientation that corresponds to the user interface that is outputted by the application. Interface rotation module 134 may be implemented in various ways. For example, interface rotation module 134 may be implemented as a downloadable or pre-installed application or “app.” In another example, interface rotation module 134 may be implemented as part of a hardware unit of computing device 110. In another example, interface rotation module 134 may be implemented as part of an operating system of computing device 110. In some instances, portions of the functionality of interface rotation module 134 may be implemented across any combination of an application, hardware unit, and operating system. For example, interface rotation module 134 may be included as part of UI module 120.

Computing device 110 may also include one or more sensor components 114. In some examples, a sensor component may be an input component that obtains environmental information of an environment that includes computing device 110. In some examples, a sensor component may be an input component that obtains information regarding the physical position, movement, and/or location information of computing device 110. For example, one or more sensor components 114 may include, but are not limited to: motion sensors (e.g., accelerometers, gyroscopes, etc.) heart rate sensors, temperature sensors, position sensors, pressure sensors (e.g., a barometer), proximity sensors (e.g., an infrared sensor), ambient light detectors, location sensors (e.g., global navigation satellite system sensors), or any other type of sensing component.

In the example of FIG. 1A, one or more applications 126 may send data to UI module 120 that causes UI module 120 to generate one or more user interfaces and elements thereof. In response, UI module 120 may output instructions and information to display 108 that cause display 108 to display the user interfaces according to the information received from UI module 120. The user interfaces may represent graphical user interfaces with which a user of computing device 110 can interact with applications and/or the operating system of computing device 110 to provide input at display 108.

When handling input detected by UIC 112, UI module 120 may receive information from UIC 112 in response to inputs detected at locations of display 108 at which elements of a user interface are displayed. UI module 120 disseminates information about inputs detected by UIC 112 to other components of computing device 110 for interpreting the inputs and for causing computing device 110 to perform one or more functions in response to the inputs.

Computing device 110 may be able to output user interfaces for display at display 108 in a plurality of interface orientations, such as a portrait orientation and a landscape orientation. When computing device 110 outputs a user interface in an interface orientation, the elements of the user interface, such as text, images, videos, controls, etc. may be oriented and/or otherwise positioned such that the elements of the user interface are designed to be properly viewed and/or interacted with while display 108 is in a corresponding orientation.

For example, when computing device 110 outputs a user interface in a landscape orientation, the elements of the user interface, such as text, images, videos, controls, etc. are oriented to be properly viewed by a user of computing device 110 when display 108 is in the landscape orientation with respect to the user. Similarly, when computing device 110 outputs a user interface in a portrait orientation, the elements of the user interface, such as text, images, videos, controls, etc. are oriented to be properly viewed by a user of computing device 110 when display 108 is in the portrait orientation with respect to the user.

One or more sensor components 114, such as one or more accelerometers, one or more gyroscopes, and/or one or more cameras, may generate sensor data that computing device 110 may use to determine the orientation of computing device 110 with respect to a frame of reference, such as the orientation of computing device 110 with respect to the Earth. If a user or another entity physically rotates or otherwise moves computing device 110, computing device 110 may be able to determine, based on the sensor data, whether the orientation of computing device 110 with respect to the frame of reference has changed because of the physical movement of computing device 110.

In some examples, a change in the orientation of computing device 110 may also cause a corresponding change in the orientation of display 108. For example, when the physical enclosure of computing device 110 includes display 108, such as in the examples where computing device 110 is a smartphone or a tablet computer, a change in the orientation of display 108 may cause a change in the aspect ratio of display 108. For example, if display 108 is rectangular in shape, computing device 110 may, when in a portrait orientation be oriented such that the height of the display is greater than the width of the display. When computing device 110 is rotated from the portrait orientation by about 90 degrees, the orientation of computing device 110 may correspondingly change from the portrait orientation to a landscape orientation where the width of the display is greater than the height of the display.

In some examples, display 108 may not be in the physical enclosure of computing device 110 but may be a separate display device (e.g., an external display) operably coupled to computing device 110. In examples where display 108 is physically separate from computing device 110, display 108 may include one or more sensor components 114 that generates sensor data that computing device 110 may use to determine the orientation of display 108 with respect to a frame of reference, such as the orientation of display 108 with respect to the Earth.

Computing device 110 may determine the orientation of display 108, such as based on sensor data generated by one or more sensor components 114, and may perform an autorotation function based on the determined orientation of display 108. Specifically, computing device 110 may perform such an autorotation function to, in response to determining a specified change in the orientation of display 108, automatically change the orientation of the user interface that is outputted for display at display 108 to an orientation of the user interface that corresponds to the determined orientation of display 108. For example, in response to determining that display 108 is in a portrait orientation, computing device 110 may output user interfaces for display at display 108 in the portrait orientation. Similarly, in response to determining that display 108 is in a landscape orientation, computing device 110 may output user interfaces for display at display 108 in the landscape orientation.

As shown in FIG. 1A, when display 108 is in the portrait orientation, computing device 110 may activate application 126A as the foreground application of computing device 110. Computing device 110 may activate an application, such as application 126A, as a foreground application by launching or otherwise opening the application (e.g., from a home screen or launcher), switching from another application to application 126A, or otherwise outputting the user interface of application 126A in the foreground of the graphical user interface for display at display 108. Because computing device 110 performs the autorotation function to orient user interfaces outputted by computing device 110 to correspond to the orientation of display 108, application 126A may, in response to being activated as the foreground application of computing device 110, output user interface 118A for display at display 108 in the portrait orientation.

After activating application 126A as the foreground application, computing device 110 may exit application 126A and may return to a home screen, also referred to as a launcher or a desktop, of computing device 110. Computing device 110 may also determine that display 108 has been rotated from being in a portrait orientation to a landscape orientation. Computing device 110 may perform the autorotation function to, in response to determining a change in the orientation of display 108 from the portrait orientation to the landscape orientation, cause computing device 110 to output user interfaces in the landscape orientation. Thus, when the home screen outputs user interface 118B, the home screen may output user interface 118B in the landscape orientation to correspond to display 108 being in the landscape orientation.

In some examples, even though computing device 110 can perform an autorotation function to change the orientation of user interfaces outputted at display 108 to correspond to the determined orientation of display 108, computing device 110 may be able to lock the display 108 to a specific interface orientation out of a plurality of interface orientations. When computing device 110 is locked to a specific interface orientation, computing device 110 may continue to output user interfaces in an interface orientation that corresponds to the specific interface orientation to which display at display 108 is locked even when the interface orientation to which display 108 is locked does not correspond to the actual (e.g., physical) orientation of display 108.

For example, computing device 110 may lock display 108 to a portrait orientation to cause computing device 110 to continue to output user interfaces in the portrait orientation even if computing device 110 determines that display 108 is in a landscape orientation. Similarly, computing device 110 may lock display 108 to a landscape orientation to cause computing device 110 to continue to output user interfaces in the landscape orientation even if computing device 110 determines that display 108 is in a portrait orientation. If computing device 110 is operably coupled to two or more displays, computing device 110 may independently lock or unlock the interface orientation of each of the two or more displays. Thus, when computing device 110 locks the interface orientation of display 108, computing device 110 may not necessarily also lock the interface orientations of other displays operably coupled to computing device 110.

In some examples, computing device 110 may lock display 108 to an interface orientation by turning off or otherwise disabling the autorotation function of computing device 110. In some examples, computing device 110 may include a physical control (e.g., a switch, a button, etc.) that the user may use to toggle the autorotation function of computing device 110 on and off. In some examples, computing device 110 may output a UI control (e.g., a button, a slider, etc.) for display at display 108 with which a user of computing device 110 may interact to enable and/or disable the autorotation function of computing device 110.

In some examples, computing device 110 may lock display 108 to display 108's current interface orientation. That is, when computing device 110 locks display 108 to an interface orientation, computing device 110 may determine the current interface orientation of display 108 and may lock display 108 to the current orientation of display 108. For example, if display 108 is in the portrait orientation when computing device 110 locks display 108's interface orientation, computing device 110 may lock display 108 to the portrait orientation. Similarly, if display 108 is in the landscape orientation when computing device 110 locks display 108's orientation, computing device 110 may lock display 108 to the landscape orientation. In the example of FIG. 1A, display 108 is in the landscape orientation while outputting user interface 118B. As such, when computing device 110 locks display 108's orientation while display 108 is in the landscape orientation, computing device 110 may therefore lock display 108 to the landscape orientation.

In some examples, computing device 110 may automatically lock display 108 to a particular interface orientation without user intervention and/or may output a suggestion to lock display 108 to a particular interface orientation. Computing device 110 may implement one or more neural networks to determine, based on factors such as a history of previous orientations of display 108, a history of computing device 110 previously locking display 108 to one or more orientations, user activities that correspond to the history of computing device 110 previously locking display 108 to one or more interface orientations, whether camera input (e.g., images captured by one or more cameras of computing device 110) indicate and/or predict the presence of and/or orientation of the face of the user relative to computing device 110, the predicted type of foreground application (e.g., video player, web browser, etc.), content currently being displayed by display 108, whether the keyboard (e.g., a virtual keyboard) of computing device 110 is currently displayed by display 108 and/or in use, and the like, whether to automatically lock display 108 to a particular interface orientation and/or whether to output a suggestion to lock display 108 to a particular interface orientation. For example, computing device 110 may use the one or more neural networks and the factors described above to determine that the user, when going to bed at night, has a history of locking display 108 to a landscape orientation. As such, computing device 110 may determine, by inputting into the one or more neural network information such as the time of the day, user activity sensed by one or more sensor components 114, user inputs at UIC 112, and the like to determine whether the user is going to bed at night. Computing device 110 may, in response to determining that the user is going to bed at night, automatically lock display 108 to the landscape orientation, or may, in response to determining that the user is going to bed at night, output a suggestion at display 108 to lock display 108 to the landscape orientation.

In some examples, computing device 110 may determine, based on the confidence of the neural network prediction, whether to automatically lock display 108 to a particular interface orientation or whether to output a suggestion to lock display 108 to a particular interface orientation. For example, if the confidence of the neural network prediction is higher than a first specified threshold, computing device 110 may automatically lock display 108 to a particular interface orientation. If the confidence of the neural network prediction is lower than the first specified threshold but higher than a second specified threshold, computing device 110 may not automatically lock display 108 to a particular interface orientation, but may instead output a suggestion to lock display 108 to a particular interface orientation.

In the example where computing device 110 determines, using the one or more neural networks, whether the user is going to bed, the one or more neural networks may output a prediction of whether the user is going to bed that is associated with a confidence score. If the confidence of the neural network prediction that the user is going to bed is higher than a first specified threshold, computing device 110 may automatically lock display 108 to a particular interface orientation. If the confidence of the neural network prediction that the user is going to bed is lower than the first specified threshold but higher than a second specified threshold, computing device 110 may not automatically lock display 108 to a particular interface orientation, but may instead output a suggestion to lock display 108 to a particular interface

In general, one or more neural networks implemented by computing device 110 may include multiple interconnected nodes, and each node may apply one or more functions to a set of input values that correspond to one or more features and provide one or more corresponding output values. The one or more features may be the sensor data generated by one or more sensor components 114, user inputs at UIC 112, and the like, and the one or more corresponding output values of one or more neural networks may be an indication of whether to lock display 108 to a particular orientation.

In some examples, the one or more neural networks may be trained on-device by computing device 110 to more accurately determine whether to lock display 108 to a particular orientation. For instance, one or more neural networks may include one or more learnable parameters or “weights” that are applied to the features. Computing device 110 may adjust these learnable parameters during the training to improve the accuracy with which one or more neural networks determine whether to lock display 108 to a particular orientation and/or for any other suitable purpose. In some examples, the one or more neural networks may be trained off-device and then downloaded to or installed at computing device 110. In some examples, the one or more neural networks may execute at a remote server system (e.g., a cloud-based server system), and computing device 110 may communicate with the remote server system to determine whether to lock display 108 to a particular orientation.

One or more applications 126 may be able to determine the particular interface orientation to which display 108 is locked and may output user interfaces in the particular interface orientation. For example, one or more applications 126 may use an orientation listener application programming interface (API) provided by the operating system of computing device 110 to determine the particular interface orientation to which display 108 is locked, and may, in response, output user interfaces in the particular interface orientation to which display 108 is locked.

In some examples, an application may be operable to output a user interface in a plurality of different interface orientations. For example, an application may be operable to output a user interface in a portrait orientation and may also be operable to output a user interface in a landscape orientation. The application may determine the particular interface orientation to which display 108 is locked and may output a user interface in the particular interface orientation.

However, some applications may not be operable to output a user interface in the particular interface orientation to which display 108 is locked. For example, an application may only be operable to output a user interface in a portrait orientation and may not be operable to output a user interface in a landscape. As such, even when display 108 is locked to a landscape orientation, the application may not be operable to output a user interface in the landscape orientation.

In some examples, while display 108 is locked to a particular interface orientation, an application that is not operable to output the user interface in the particular interface orientation to which display 108 is locked may continue to output a user interface in an interface orientation that is different from the particular interface orientation to which display 108 is locked. For example, if the application is operable to output a user interface in a portrait orientation, the application may continue to output a user interface in the portrait orientation when display 108 is locked to a landscape orientation.

However, outputting a user interface in an orientation that is different from the particular interface orientation to which display 108 is locked may provide a poor user experience to the user of computing device 110. A user of computing device 110 may have locked display 108 to a particular interface orientation because the user may be physically positioned in a way that makes content being displayed in the particular interface orientation more comfortable to view for the user compared to other interface orientations.

A user of computing device 110 may therefore find it uncomfortable or otherwise difficult to view and/or interact with content being displayed at display 108 in an interface orientation that is different from the particular interface orientation to which display 108 is locked. Thus, an application that outputs a user interface in an interface orientation that is different from the particular interface orientation to which display 108 is locked may cause the user to reposition their body and/or computing device 110 to more comfortably view the user interface in the interface orientation that is different from in the particular interface orientation to which display 108 is locked.

The user may not be focused on viewing the display 108 while the user is repositioning their body and/or computing device 110 even though the application may continue to output the user interface for display at display 108. As such, outputting a user interface in an interface orientation that causes the user to reposition their body and/or computing device may increase the amount of time the application's user interface may be required to be outputted for display at display 108 in order for the user to focus on viewing the application's interface. Increasing the amount of time the application's user interface is required to be outputted for display at display 108 may increase the amount of battery power consumed by display 108 to display the user interface that is outputted by the application.

Aspects of this disclosure may overcome the technical problems described above by outputting user interfaces for display at display 108 in ways that reduce the number of times the user may reposition their body and/or computing device 110 to more comfortably view the user interfaces displayed at display 108. Reducing the amount of times the user may reposition their body and/or computing device 110 to more comfortably view the user interfaces displayed at display 108 may increase the amount of time the user is focused on viewing display 108. Increasing the amount of time the user is focused on viewing display 108 may reduce the amount of time an application's user interface may be required to be outputted for display at display 108 for the user to focus on viewing display 108, thereby reducing the amount of battery power consumed by display 108 to display the user interface that is outputted by the application.

In accordance with aspects of the present disclosure, computing device 110 may activate, as a foreground application, an application that is operable to output a user interface in an interface orientation different from the interface orientation to which display 108 is locked but is not operable to output the user interface in the interface orientation to which display 108 is locked. Computing device 110 may activate an application as a foreground application by launching or otherwise opening the application (e.g., from a home screen or launcher), switching from another application to the application, or otherwise outputting the user interface of the application in the foreground of the graphical user interface for display at display 108.

In the example of FIG. 1A, a user may interact with user interface 118B of the home screen to, for example, launch applications at computing device 110. User interface 118B includes application icons 122A-122D (“application icons 122”), each of which may correspond to an application of one or more applications 126, and the user may provide user input that corresponds to the selection of an application icon (e.g., out of application icons 122) to launch the application that corresponds to the selected application icon.

For example, the user may provide user input that corresponds to the selection of application icon 122D, which corresponds to application 126A, such as by providing touch input to tap application icon 122D. Computing device 110 may, in response to receiving the user input that corresponds to the selection of application icon 122D, activate application 126A that corresponds to the selected application icon 122D as the foreground application of computing device 110.

While application 126A is operable to output a user interface in the portrait orientation, such as user interface 118A outputted in the portrait orientation, application 126A is not operable to output a user interface in the landscape orientation to which display 108 is locked. For example, the application may be operable to output a user interface in the portrait orientation regardless of the determined orientation of display 108 and/or computing device 110, and regardless of the interface orientation to which display 108 is locked.

Computing device 110 may, based on display 108 being locked to an interface orientation and further based on the application not being operable to output a user interface in the interface orientation to which display 108 is locked, generate a re-oriented user interface for the application in the interface orientation to which display 108 is locked. Computing device 110 may therefore output the re-oriented user interface for display at display 108 in the interface orientation to which display 108 is locked. That is, computing device 110 may be able to output a user interface of the application in the interface orientation to which display 108 is locked, even if the application does not support outputting a user interface in the interface orientation to which display 108 is locked.

In some examples, because the application is not operable to output a user interface in the interface orientation to which display 108 is locked, computing device 110 may send, to interface rotation module 134, data for outputting a user interface in an interface orientation different from the interface orientation to which display 108 is locked. Interface rotation module 134 may, in response to receiving, from the application, the data for outputting the user interface, generate a re-oriented user interface for the application in the interface orientation to which display 108 is locked.

The data for outputting a user interface sent by the application may include information such as indications of the UI elements (e.g., interface such as UI controls, text, images, videos, etc.) in the user interface of the application, indications of the positioning and/or layout of the UI elements such as constraints, distances of the UI elements from each other and/or from the edges of the user interface, functions of the application associated with the UI controls, and the like. Interface rotation module 134 may use such data sent by the application to generate a re-oriented user interface in the interface orientation to which display 108 is locked that corresponds to the user interface associated with the data sent by the application. For example, interface rotation module 134 may generate a re-oriented user interface that includes the UI elements indicated by the data for outputting a user interface sent by the application, where the UI elements in the re-oriented user interface are oriented to be properly viewed (e.g., oriented to be right side up) in the interface orientation to which display 108 is locked.

In the example of FIG. 1A, computing device 110 that has locked display 108 to the landscape orientation may, in response to activating application 126A as the foreground application, wherein application 126A may be operable to output a user interface only in a portrait orientation, generate a re-oriented user interface 118C in the landscape orientation. Application 126A may, in response to being activated as the foreground application, send data for outputting the user interface in the portrait orientation to interface rotation module 134. Interface rotation module 134 may, in response to receiving the data from application 126A, generate, based on the data for outputting the user interface in the portrait orientation, a re-oriented user interface 118C for application 126A that corresponds to the user interface in the portrait orientation outputted by application 126A. Interface rotation module 134 may therefore output (e.g., via UI module 120) re-oriented user interface 118C of application 126A for display at display 108 in the landscape orientation.

In some examples, to re-orient a user interface from a first orientation to a second orientation, computing device 110 may resize and re-orient the user interface in the first orientation to generate the re-oriented user interface in the second orientation. As shown in FIG. 1B, when display 108 is in the portrait orientation, computing device 110 may activate application 126A as the foreground application of computing device 110, and application 126A may, in response to being activated as the foreground application of computing device 110, output user interface 118A for display at display 108 in the portrait orientation.

After activating application 126A as the foreground application, computing device 110 may exit application 126A and may return to a home screen application. Computing device 110 may also determine that display 108 has been rotated from being in a portrait orientation to a landscape orientation. Thus, when the home screen outputs user interface 118B, computing device 110 may perform autorotation to output user interface 118B for the home screen in the landscape orientation to correspond to display 108 being in the landscape orientation.

The user may provide user input that corresponds to the selection of application icon 122D in user interface 118B, which corresponds to application 126A, such as by providing touch input to tap application icon 122D. Computing device 110 may, in response to receiving the user input that corresponds to the selection of application icon 122D, activate application 126A that corresponds to the selected application icon 122D as the foreground application of computing device 110.

While application 126A is operable to output a user interface in the portrait orientation, such as user interface 118A outputted in the portrait orientation, application 126A is not operable to output a user interface in the landscape orientation to which display 108 is locked. As such, computing device 110 may, based on display 108 being locked to an interface orientation and further based on the application not being operable to output a user interface in the interface orientation to which display 108 is locked, generate a re-oriented user interface for the application in the interface orientation to which display 108 is locked. Computing device 110 may therefore output the re-oriented user interface for display at display 108 in the interface orientation to which display 108 is locked.

In some examples, because the application is not operable to output a user interface in the interface orientation to which display 108 is locked, computing device 110 may send, to interface rotation module 134, data for outputting a user interface in an interface orientation different from the interface orientation to which display 108 is locked. Interface rotation module 134 may, in response to receiving, from the application, the data for outputting the user interface, generate a re-oriented user interface for the application in the interface orientation to which display 108 is locked.

In some examples, interface rotation module 134 may generate a re-oriented user interface for the application by rotating and resizing (e.g., scaling) the user interface that the application is operable to output. That is, interface rotation module 134 may rotate the user interface to the interface orientation to which display 108 is locked and may resize the rotated user interface to fit within display 108.

In the example of FIG. 1B, computing device 110 having display 108 locked to the landscape orientation may, in response to activating application 126A as the foreground application, wherein application 126A may be operable to output a user interface only in a portrait orientation, generate a re-oriented user interface 118D in the landscape orientation. Application 126A may, in response to being activated as the foreground application, output a user interface in the portrait orientation and may send data for outputting the user interface in the portrait orientation to interface rotation module 134. Interface rotation module 134 may, in response to receiving the data from application 126A, generate, based on the data, a re-oriented user interface 118D for application 126A in the landscape orientation that corresponds to the user interface 118A in the portrait orientation outputted by application 126A.

To generate the re-oriented user interface 118D for application 126A in the landscape orientation that corresponds to the user interface 118A in the portrait orientation outputted by application 126A, interface rotation module 134 may rotate user interface 118A by 90 degrees and may resize the rotated user interface 118A so that the height of the rotated user interface 118A corresponds to (e.g., is the same as) the height of display 108 in the landscape orientation. Interface rotation module 134 may therefore output re-oriented user interface 118D of application 126A (e.g., via UI module 120) for display at display 108 in the landscape orientation.

In some examples, computing device 110 may generate a re-oriented user interface for an application based at least in part on changing the result of APIs called by the application. When the application determines to output a user interface, the application may call an API provided by the operating system to query the type of user interface to be outputted by the application. For example, the application may use the APIs to query the operating system regarding whether the application is to render a user interface for a tablet device (e.g., a user interface in a landscape orientation). If the application receives a response to the query indicating that the application is to render a user interface for a smart phone (e.g., in a portrait orientation), then the application may render the user interface for the smart phone.

In the example of FIG. 1B, when application 126A is activated, application 126A may query, via the APIs the type of user interface to be outputted by application 126A. Even though display 108, in the example of FIG. 1B, is locked to a portrait orientation, computing device 110 may return a response to the query indicating that application 126A is to render user interface 118D in a portrait orientation. Application 126A may therefore, in response to receiving the response to the query indicating that application 126A is to render user interface 118D in a portrait orientation, output user interface 118D in a portrait orientation, which interface rotation module 134 may resize and rotate to be outputted in a landscape orientation for display at display 108.

In some examples, computing device 110 may be able to re-orient media content, such as images, videos, and multimedia content from a first orientation to a second orientation to output the media content in the second orientation. As shown in FIG. 1C, when display 108 is in the landscape orientation, computing device 110 may activate application 126B as the foreground application of computing device 110. In some examples, application 126B may be a media player (e.g., a video player) for outputting media content such as images, videos, and the like. As such, application 126B may, when executing as the foreground application of computing device 110, output media content 130A, which may be a video, for display at display 108 in the landscape orientation, which corresponds to the orientation of display 108.

After activating application 126B as the foreground application, computing device 110 may exit application 126B and may return to a home screen. Computing device 110 may also determine that display 108 has been rotated from being in a landscape orientation to a portrait orientation. Thus, when the home screen outputs user interface 118D, computing device 110 may perform auto-rotation to output user interface 118D in the portrait orientation to correspond to display 108 being in the portrait orientation.

The user may provide user input that corresponds to the selection of application icon 122C in user interface 118D, which corresponds to application 126B, such as by providing touch input to tap application icon 122C. Computing device 110 may, in response to receiving the user input that corresponds to the selection of application icon 122C, activate application 126B that corresponds to the selected application icon 122C as the foreground application of computing device 110.

While application 126B is operable to output media content in the landscape orientation, such as media content 130A outputted in the landscape orientation, application 126B is not operable to output media content in the portrait orientation to which display 108 is locked. As such, computing device 110 may, based on display 108 being locked to an interface orientation and further based on the application not being operable to output media content in the interface orientation to which display 108 is locked, transform media content to the interface orientation to which display 108 is locked. Computing device 110 may therefore output the transformed media content for display at display 108 in the interface orientation to which display 108 is locked.

In the example of FIG. 1C, computing device 110 having display 108 locked to the portrait orientation may, in response to activating application 126B as the foreground application, wherein application 126B may be operable to output media content only in a landscape orientation, transform media content outputted by application 126B from the landscape orientation to a transformed media content in the portrait orientation by rotating and/or scaling media content to generate the transformed media content. For example, application 126B may send data for outputting the media content in the landscape orientation to interface rotation module 134. Interface rotation module 134 may, in response to receiving the data from application 126B, generate, based on the data, transformed media content 130B for application 126B in the portrait orientation that corresponds to media content 130A in the landscape orientation outputted by application 126B.

To generate transformed media content 130B for application 126B in the portrait orientation that corresponds to media content 130A in the landscape orientation outputted by application 126B, interface rotation module 134 may rotate media content 130B by 90 degrees and may resize (e.g., scale) the rotated media content 130A so that the width of the rotated media content 130A corresponds to (e.g., is the same as) the width of display 108 in the portrait orientation. Interface rotation module 134 may therefore output transformed media content 130B of application 126B for display at display 108 in the portrait orientation.

In some examples, computing device 110 may implement one or more neural networks to determine whether to transform a media content in an interface orientation different from the interface orientation to which display 108 is locked to a transformed media content in the interface orientation to which display 108 is locked. Computing device 110 may make such a determination based on factors such as a history of computing device previously transforming media content in an interface orientation different from the interface orientation to which display 108 is locked to a transformed media content in the interface orientation to which display 108 is locked, a history of whether the user has correspondingly provided input to disable the locking of display 108 in response to computing device 110 transforming the media content to the transformed media content, the history of landscape orientations to which display 108 is locked that corresponds to the previous transformations of media content, information associated with the transformed media content (e.g., aspect ratios, media type, file size, etc.), and the like.

For example, computing device 110 may use the one or more neural networks and the factors described above to determine that the user is likely to refrain from unlocking the interface orientation of display 108 in response to computing device 110 transforming media content in a landscape orientation to a portrait orientation, but is likely to unlock the interface orientation of display 108 from a landscape orientation in response to computing device 110 transforming media content in a portrait orientation to a landscape orientation. As such, in this example, computing device 110 may determine, using the one or more neural networks and factors such as the current interface orientation to which display 108 is locked, whether to transform media content in a portrait orientation to a landscape orientation when display 108 is locked to the landscape orientation.

In another example, computing device 110 may use the one or more neural networks and the factors described above to determine that, when display 108 is locked to a portrait orientation, the user is likely to refrain from unlocking the interface orientation of display 108 from the portrait orientation in response to computing device 110 transforming media content in a 16:9 or smaller aspect ratio from a landscape orientation to a portrait orientation, but is likely to unlock the interface of display 108 from the portrait orientation in response to computing device 110 transforming media content in a 1.77:1 or greater aspect ratio from the landscape orientation to the portrait orientation. As such, in this example, computing device 110 may determine, using the one or more neural networks and factors such as the aspect ratio of the media content, whether to transform media content in a landscape orientation to a portrait orientation when display 108 is locked to the portrait orientation.

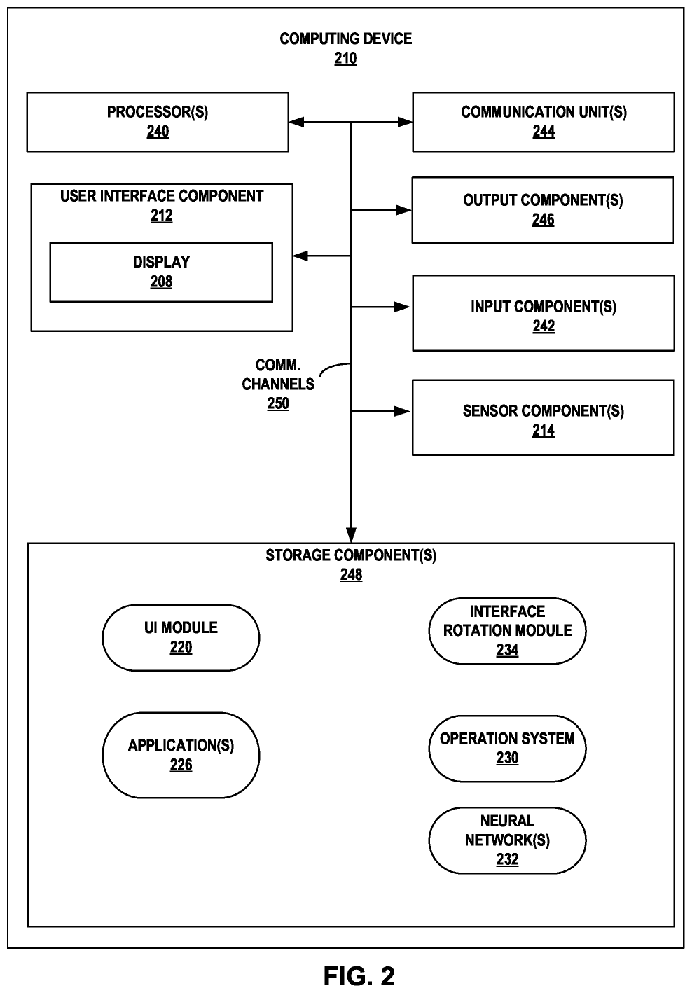

FIG. 2 is a block diagram illustrating further details of an example computing device, in accordance with one or more aspects of the present disclosure. Computing device 210 of FIG. 2 is described below as an example of computing device 110 as illustrated in FIGS. 1A-1C.

Computing device 210 of FIG. 2 may be an example of a mobile phone, a tablet computer, a laptop computer, a desktop computer, a server, a mainframe, a set-top box, a television, a wearable device, a home automation device or system, a PDA, a gaming system, a media player, an e-book reader, a mobile television platform, an automobile navigation or infotainment system, or any other type of mobile, non-mobile, wearable, and non-wearable computing device configured to receive, and output an indication of notification data. FIG. 2 illustrates only one particular example of computing device 210, and many other examples of computing device 210 may be used in other instances and may include a subset of the components included in example computing device 210 or may include additional components not shown in FIG. 2.

As shown in the example of FIG. 2, computing device 210 includes user interface component (UIC) 212, one or more sensor components 214, one or more processors 240, one or more input components 242, one or more communication units 244, one or more output components 246, and one or more storage components 248. UIC 212 includes display 208. One or more storage components 248 of computing device 210 also include UI module 220, one or more applications 226, operating system 230, interface rotation module 234, and one or more neural networks 232.

Communication channels 250 may interconnect each of the components 240, 212, 214, 244, 246, 242, and 248 for inter-component communications (physically, communicatively, and/or operatively). In some examples, communication channels 250 may include a system bus, a network connection, an inter-process communication data structure, or any other method for communicating data.

One or more sensor components 214 are examples of one or more sensor components 114 shown in FIGS. 1A-1C and may be any component configured to obtain environmental information about the circumstances surrounding computing device 210 and/or the physical position, movement, and/or location information of computing device 210. Examples of one or more sensor components 214 may include location sensors (e.g., global navigation satellite system components), temperature sensors, motion sensors (e.g., multi-axial accelerometers, gyroscopes, gravity sensors, etc.), pressure sensors, ambient light sensors, and the like. One or more sensor components 215 are configured to generate sensor data that computing device 210 may use to determine the orientation of computing device 210 with respect to a frame of reference, such as the orientation of computing device 210 with respect to the Earth.

One or more input components 242 of computing device 210 may receive input. Examples of input are tactile, audio, and video input. One or more input components 242 of computing device 210, in one example, includes a presence-sensitive display, touch-sensitive screen, mouse, keyboard, voice responsive system, video camera, microphone or any other type of device for detecting input from a human or machine.

One or more output components 246 of computing device 210 may generate output. Examples of output are tactile, audio, and video output. One or more output components 246 of computing device 210, in one example, includes a presence-sensitive display, sound card, video graphics adapter card, speaker, liquid crystal display (LCD), organic light-emitting diode (OLED) display, a light field display, one or more haptic motors, one or more linear actuating devices, or any other type of device for generating output to a human or machine.

One or more communication units 244 of computing device 210 may communicate with external devices via one or more wired and/or wireless networks by transmitting and/or receiving network signals on the one or more networks. Examples of one or more communication units 244 include a network interface card (e.g., an Ethernet card), an optical transceiver, a radio frequency transceiver, a global navigation satellite system receiver (e.g., a Global Positioning System receiver), or any other type of device that can send and/or receive information. Other examples of one or more communication units 244 may include short wave radios, cellular data radios, wireless network radios, as well as universal serial bus (USB) controllers.

UIC 212 of computing device 200 may be an example of UIC 112 shown in FIGS. 1A-1C and may be hardware that functions as an input and/or output device for computing device 210. For example, UIC 212 may include display 208, which may be an example of display 108 shown in FIGS. 1A-1C, and which may be a screen at which information is displayed. Display 208 may in some examples be a presence-sensitive display.

One or more processors 240 may implement functionality and/or execute instructions within computing device 210. For example, one or more processors 240 on computing device 210 may receive and execute instructions stored by one or more storage components 248 that execute the functionality of UI module 220, one or more applications 226, and operating system 230. The instructions executed by one or more processors 240 may cause computing device 210 to store information within one or more storage components 248 during program execution. Examples of one or more processors 240 include application processors, display controllers, sensor hubs, and any other hardware configured to function as a processing unit. One or more processors 240 may execute instructions of UI module 220, one or more applications 226, operating system 230, interface rotation module 234 and one or more neural networks 232 to perform actions or functions. That is, UI module 220, one or more applications 226, operating system 230, interface rotation module 234 and one or more neural networks 232 may be operable by one or more processors 240 to perform various actions or functions of computing device 210.

One or more storage components 248 within computing device 210 may store information for processing during operation of computing device 210. That is, computing device 210 may store data accessed by UI module 220, one or more applications 226, operating system 230, interface rotation module 234 and one or more neural networks 232 during execution at computing device 210. In some examples, one or more storage component 248 is a temporary memory, meaning that a primary purpose of one or more storage component 248 is not long-term storage. One or more storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

One or more storage components 248, in some examples, also include one or more computer-readable storage media. One or more storage components 248 may be configured to store larger amounts of information than volatile memory. One or more storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. One or more storage components 248 may store program instructions and/or information (e.g., data) associated with UI module 220, one or more applications 226, operating system 230, interface rotation module 234 and one or more neural networks 232. UI module 220, one or more applications 226, interface rotation module 234 and one or more neural networks 232 may execute at one or more processors 240 to perform functions similar to that of UI module 120, one or more applications 126, and interface rotation module 134, respectively, shown in FIGS. 1A-1C.

One or more neural networks 232 may implemented by computing device 210 as software, hardware, or a combination thereof. One or more neural networks 232 may include multiple interconnected nodes, and each node may apply one or more functions to a set of input values that correspond to one or more features, and provide one or more corresponding output values. One or more neural networks 232 may be an example of and may perform functions similar to that of the neural networks described throughout this disclosure.

In some examples, one or more neural networks 232 may be trained on-device by computing device 210. For instance, one or more neural networks 232 may include one or more learnable parameters or “weights” that are applied to the features. Computing device 210 may adjust these learnable parameters during the training to improve the accuracy of one or more neural networks 232. In some examples, one or more neural networks 232 may be trained off-device and then downloaded to or installed at computing device 210.

Operating system 230 may execute at one or more processors 240 to cause computing device 210 to perform various functions to manage hardware resources of computing device 210, to manage the processes executing at one or more processors 240, and/or to provide various common services for other software applications and processes that execute at one or more processors 240.

Operating system 230 may execute at one or more processors 240 to determine, based on sensor data generated by one or more sensor components 214, the orientation of computing device 210 with respect to a frame of reference, such as the orientation of computing device 210 with respect to the Earth. If a user or another entity physically rotates or otherwise moves computing device 210, operating system 230 may be able to determine, based on the sensor data, whether the orientation of computing device 210 has changed because of the physical movement of computing device 210.

Physical movement of computing device 210 that causes a change in the orientation of computing device 210 may also cause a corresponding change in the orientation of display 208. For example, if computing device 210 includes display 208, such as when computing device 210 is a smartphone or a tablet computer, the orientation of display 208 may correspond to the orientation of computing device 210. As such, operating system 230 may be configured to determine, based on sensor data generated by one or more sensor components 214, the orientation of display 208 as well as changes in the orientation of display 208.

Operating system 230 may execute at one or more processors 240 to determine the orientation of display 208, such as based on sensor data generated by one or more sensor components 214, and may perform an autorotation function based on the determined orientation of display 208. Specifically, operating system 230 may perform such an autorotation function to, in response to determining a specified change in the orientation of display 208, automatically change the orientation of the user interface that is outputted for display at display 208 to an orientation of the user interface that corresponds to the determined orientation of display 208.

To provide an autorotation function, operating system 230 may determine the orientation of display 208, and operating system 230 may provide an API that one or more applications 226 may use to determine the orientation of display 208 to output interfaces in an interface orientation that corresponds to the orientation of display 208. For example, one or more application 226 may use the API to determine that display 208 is in a portrait orientation and may correspondingly output user interfaces in the portrait orientation. Similarly, one or more application 226 may use the API to determine that display 208 is in a landscape orientation and may correspondingly output user interfaces in the landscape orientation.

In some examples, operating system 230 may execute at one or more processors 240 to lock the display 208 to a specific interface orientation out of a plurality of orientations. Operating system 230 may lock display 208 to an orientation by turning off or otherwise disabling the autorotation function of operating system 230. In some examples, computing device 210 may include a physical control (e.g., a switch, a button, etc.) that the user may use to toggle the autorotation function of computing device 210. In some examples, operating system 230 may output a UI control (e.g., a button, a slider, etc.) for display at display 208 with which a user of computing device 210 may interact to enable and/or disable the autorotation function of computing device 210.

In some examples, operating system 230 may use one or more neural networks 232 to automatically (i.e., without user intervention) lock display 208 to an interface orientation based on factors as historical patterns of usage of computing device 210, current usage of computing device 210, environmental factors (e.g., the current time of the day, the current date, etc.) and/or any other suitable factors. For example, operating system 230 may input data indicative of such factors to one or more neural networks 232, and one or more neural network 232 may, in response, output an indication of whether to lock display 208 to an interface orientation. Operating system 230 may therefore determine, based on the output of one or more neural networks 232, whether to lock display 208 to an interface orientation.

In some examples, operating system 230 may lock display 208's interface orientation to display 208's current orientation. That is, when operating system 230 locks display 208 to an orientation, operating system 230 may determine the current orientation of display 208 and may lock display 208 to the current orientation of display 208. In some examples, operating system 230 may receive user input (e.g., at one or more input components 242) that indicates the orientation to which display 208 is locked, operating system 230 may lock display 208's orientation to the orientation indicated by the user input.

In some examples, while the interface orientation is locked to a particular interface orientation, an application of one or more application 226 may not be operable to output the user interface in the particular interface orientation to which display 208 is locked may continue to output a user interface in an interface orientation that is different from the particular interface orientation to which the interface orientation is locked. For example, while display 208 is locked to a landscape orientation an application may only be able to output a user interface in a portrait orientation and may not be able to output a user interface in a landscape orientation

While display 208 is locked to an interface orientation, operating system 230 may execute at one or more processors 240 to activate, as a foreground application, an application that is operable to output a user interface in an interface orientation different from the interface orientation to which display 208 is locked but is not operable to output the user interface in the interface orientation to which display 208 is locked. Operating system 230 may activate an application as a foreground application by launching or otherwise opening the application (e.g., from a home screen or launcher), switching from another application to the application, or otherwise outputting the user interface of the application in the foreground of the graphical user interface for display at display 208.

Interface rotation module 234 may execute at one or more processors 240 to, based on display 208 being locked to an interface orientation and further based on the application not being operable to output a user interface in the interface orientation to which display 208 is locked, generate a re-oriented user interface for the application in the interface orientation to which display 208 is locked. Interface rotation module 234 may therefore output the re-oriented user interface for display at display 208 in the interface orientation to which display 208 is locked.

The application may send, to interface rotation module 234, data for outputting a user interface in an interface orientation different from the interface orientation to which display 208 is locked. Interface rotation module 234 may, in response to receiving, from the application, the data for outputting the user interface, generate a re-oriented user interface for the application in the interface orientation to which display 208 is locked, and may output, for display at display 208, the re-oriented user interface in the interface orientation to which display 208 is locked.

The data for outputting a user interface sent by the application to interface rotation module 234 may include information such as indications of the UI elements (e.g., interface such as UI controls, text, images, videos, etc.) in the user interface, indications of the positioning and/or layout of the UI elements such as constraints, distances of the UI elements from each other and/or from the edges of the user interface, functions of the application associated with the UI controls, and the like. Interface rotation module 234 may use such data sent by the application to generate a re-oriented user interface in the interface orientation to which display 208 is locked that corresponds to the user interface associated with the data sent by the application.

In some examples, interface rotation module 234 may generate a re-oriented user interface that includes the UI elements indicated by the data for outputting a user interface sent by the application, where the UI elements in the re-oriented user interface are oriented to be properly viewed (e.g., oriented to be right side up) in the interface orientation to which display 208 is locked. In some examples, interface rotation module 234 may generate a re-oriented user interface for the application by rotating and resizing the user interface that the application is operable to output. That is, interface rotation module 234 may rotate the user interface to the interface orientation to which display 208 is locked and may resize the rotated user interface to fit within display 208 in the interface orientation to which display 208 is locked.

In some examples, interface rotation module 234 may execute at one or more processors 240 to re-orient media content, such as images, videos, and multimedia content, to the interface orientation to which display 208 is locked. from a first orientation to a second orientation to output the media content in the second orientation. For example, an application may send, to interface rotation module 234, data for outputting the media content in an interface orientation different from the interface orientation to which display 208 is locked. Interface rotation module 234 may, in response to receiving the data, generate, based on the data, transformed media content in the interface orientation to which display 208 is locked, such as by rotating the media content to the interface orientation to which display 208 is locked and may resize the rotated media content to fit within display 208 in the interface orientation to which display 208 is locked.

In some examples, when display 208 is locked to a particular interface orientation, operating system 230 may execute at one or more processors 240 to output the home screen and/or the lock screen of computing device 210 in an interface orientation different from the particular interface orientation to which display 208 is locked. For example, display 208 may be associated with a primary orientation, which may be a pre-set default orientation for display 208. When display 208 is locked to a particular interface orientation different from the primary orientation associated with display 208, operating system 230 may, when transitioning to the home screen or lock screen of computing device 210, output the home screen and/or lock screen for display at display 208 in the primary orientation associated with display 208, even if the primary orientation associated with display 207 is different from the particular interface orientation to which display 208 is locked.

In some examples, when display 208 is locked to a particular interface orientation, operating system 230 may execute at one or more processors 240 to output a user interface of an application in an interface orientation different from the particular interface orientation to which display 208 is locked. For example, one or more neural networks 232 may determine, based on factors such as a history of previous orientations of user interfaces of the application outputted for display at display 208, a history of whether the user provided input to cause the user interfaces of the application to be outputted in a different orientation than the orientation of the user interfaces outputted for display at display 208, and the like, to determine whether to output the user interface of an application in an interface orientation different from the interface orientation to which display 208 is locked.

In some examples, when display 208 outputs a user interface of an application in an interface orientation different from the particular interface orientation to which display 208 is locked, operating system 230 may enable one or more applications 226 to output user interfaces in the interface orientation different from the particular interface orientation to which display 208 is locked. That is, computing device 210 may determine the interface orientation in which display 208 displays a user interface of as the most recent orientation of display 208, and may output a subsequent user interface of another application for display at display 208 in the most recent orientation of display 208, even if the most recent orientation of display 208 is different from the particular interface orientation to which display 208 is locked.

In some examples, operating system 230 may be able to adaptively change the interface orientation to which display 208 is locked. When display 208 is locked to a first interface orientation, operating system 230 may, based on computing device 210 outputting one or more user interfaces in a second interface orientation different from the first interface orientation to which display 208 is locked, adaptively unlock display 208 from the first interface orientation.

In some examples, operating system 230 may adaptively change the interface orientation to which display 208 is locked based on the amount of time during which computing device 210 outputs one or more user interfaces in a second interface orientation different from the first interface orientation to which display 208 is locked. If the amount of time during which computing device 210 outputs one or more user interfaces in a second interface orientation different from the first interface orientation to which display 208 is locked exceeds a threshold amount of time, such as five minutes, ten minutes, and the like, operating system 230 may adaptively unlock display 208 from the first interface orientation.

In some examples, operating system 230 may use one or more neural networks 232 to adaptively change the orientation to which display 208 is locked based on factors as historical patterns of usage of computing device 210, current usage of computing device 210, environmental factors (e.g., the current time of the day, the current date, etc.), the type of user interface and/or media content currently being displayed at display 208, and/or any other suitable factors. For example, operating system 230 may input data indicative of such factors to one or more neural networks 232, and one or more neural network 232 may, in response, output an indication of whether to adaptively change the interface orientation to which display 208 is locked. Operating system 230 may therefore determine, based on the output of one or more neural networks 232, whether to adaptively change the interface orientation to which display 208 is locked.

In some examples, each of a plurality of applications at computing device 210 may be associated with a respective interface orientation lock setting, so that different applications may, when activated as the foreground application, lock the display to an interface orientation specified by the interface orientation lock setting associated with the application. For example, an application that is associated with a portrait orientation may, in response to being activated as a foreground application, lock the display to the portrait orientation even when the display is already locked to a landscape orientation. Similarly, an application that is associated with a landscape orientation may, in response to being activated as a foreground application, lock the display to the landscape orientation even when the display is already locked to a portrait orientation.

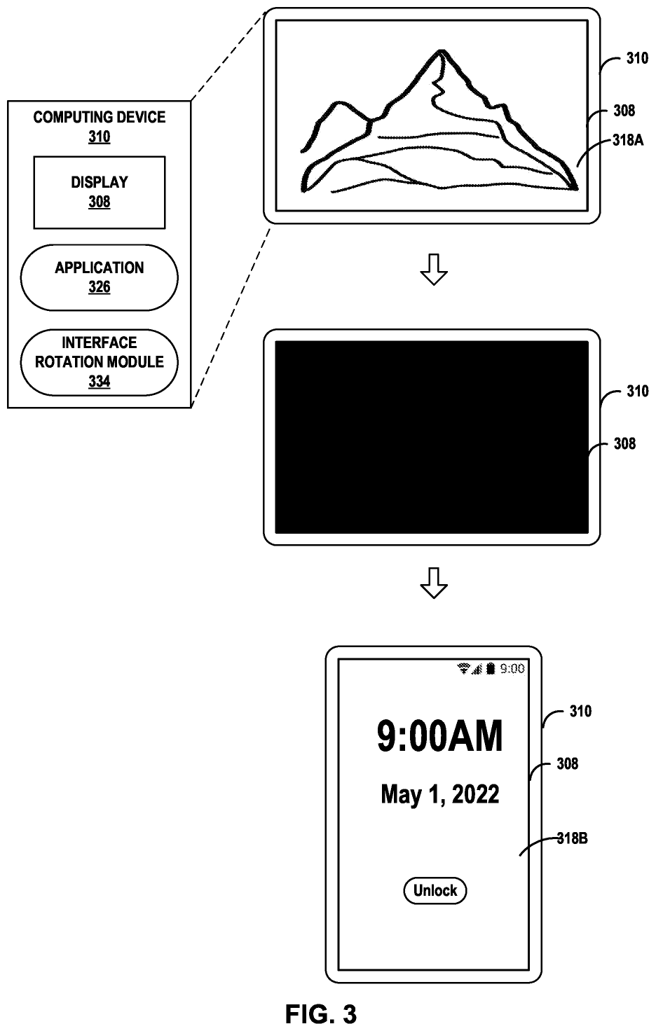

FIG. 3 is a conceptual diagram illustrating another example of a computing device that performs adaptive user interface rotation, in accordance with one or more aspects of the present disclosure. Computing device 310 of FIG. 3 is described below as an example of computing device 110 as illustrated in FIGS. 1A-1C and computing device 210 as illustrated in FIG. 2.

In the example of FIG. 3, display 308 may be locked to a landscape orientation and computing device 310 may output user interface 318A of application 326 for display at display 308 in the landscape orientation. If application 326 is not operable to output a user interface in the landscape orientation, interface rotation module 334, which is an example of interface rotation module 134 of FIGS. 1A-1C, may determine, based on the user interface of application 326 in the portrait orientation, a re-oriented user interface 318A in the landscape orientation, according to the techniques described throughout this disclosure, and may output user interface 318A of application 326 for display at display 308 in the landscape orientation.

Computing device 310 may unlock display 308 from an interface orientation (i.e., re-enable the autorotation feature of computing device 310) when computing device 310 exits a sleep state. For example, while display 308 is locked in the landscape orientation, computing device 310 may transition from an awake state, which may be a state in which display 308 is turned on and displaying user interfaces (e.g., user interface 318A), to a sleep state, which may be a state in which display 308 is turned off. Computing device 310 may transition to the sleep state in response to receiving user input that directs computing device 310 to enter the sleep state, such as by the user pressing the power button of the computing device 310, which is also sometimes referred to as a sleep/wake button or a side button. Computing device 310 may also enter the sleep state in response to user inactivity. For example, if computing device 310 does not detect any user input at computing device 310 for a specified period of time, such as 30 seconds, one minute, two minutes, five minutes, and the like, computing device 310 may enter the sleep state. Computing device 310 may, as part of entering the sleep state, turn off display 308.

When computing device 310 is in the sleep state, computing device 310 may transition from the sleep state to an awake state, such as in response to receiving user input that directs computing device 310 to transition out of the sleep state to the awake state. Such user input may include the user pressing the power button of the computing device 310 while computing device 310 is in the sleep state, touch input at display 308, and the like.

When the computing device 310 transitions from the sleep state to the awake state, computing device 310 may turn on display 308, and display 308 may display a lock screen, also referred to as a login screen, which may be a user interface with which a user may interact to authenticate the user as an authorized user of computing device 310. When the computing device 310 transitions from the sleep state to the awake state, computing device 310 may, in some examples, also unlock display 308 from the landscape orientation, and may re-enable the autorotation function of computing device 310.

As such, even though display 308 was locked to a landscape orientation prior to computing device 310 transitioning from the awake state to the sleep state, computing device 310 may, in response to computing device 310 transitioning from the sleep state to the awake state, unlock display 308 from the landscape orientation, thereby enabling computing device 310 to output a user interface for the lock screen in either the portrait orientation or the landscape orientation. In the example of FIG. 3, computing device 310 may determine that display 308, after computing device 310 transitioning from the sleep state to the awake state, is in the portrait orientation, and may therefore perform autorotation to output user interface 318B of the lock screen in the portrait orientation.

In some examples, when the computing device 310 transitions from the sleep state to the awake state, computing device 310 may refrain from unlocking display 308 from the orientation (e.g., landscape orientation) to which display 308 was locked prior to entering the sleep state. That is, if display 308 was locked to an orientation prior to transitioning to the sleep state, display 308 may remain locked to the same orientation after transitioning out of the sleep state to the awake state.

Even though display 308 may remain locked to an interface orientation after transitioning to the awake state, computing device 310 may output user interface 318B of the lock screen in an interface orientation different from the interface orientation to which display 308 is locked. For example, if computing device 310 determines that display 308 is oriented in a primary orientation, computing device 310 may output user interface 318B of the lock screen in the primary orientation even if the primary orientation is different from the interface orientation to which display 308 is locked.

A primary orientation of display 308 may be a default orientation that is pre-set in computing device 310, such as by the manufacturer of computing device 310. In some examples, a primary orientation may be the orientation of display 308 when computing device 310 is being naturally held by the user of computing device 310. For example, because a mobile phone may typically be naturally held by users in such a way that display 308 is in a portrait orientation, if computing device 310 is a mobile phone, then the primary orientation of display 308 is the portrait orientation. In some examples, some tablet computers may typically be naturally held in such a way that display 308 is in a landscape orientation. As such, if computing device 310 is a tablet computer, the primary orientation of display 308 is the landscape orientation.

As such, computing device 310 may, in response to transitioning from the sleep state to the awake state, determine whether the display 308 is in the primary orientation that is different from the interface orientation to which display 308 is locked. If computing device 310 determines that the display 308 is in the primary orientation that is different from the interface orientation to which display 308 is locked, computing device 310 may output the user interface 318B of the lock screen in the primary orientation.

In the example of FIG. 3, the primary orientation of display 308 may be the portrait orientation. Thus, if computing device 310 determines that display 308 is in the portrait orientation after transitioning from the sleep state to the awake state, computing device 310 may output user interface 318B of the lock screen in the portrait orientation.

In some examples, when the computing device 310 exits an application and returns to a home screen, computing device 310 may output the home screen in the primary orientation of display 308 even when display 308 is locked to an interface orientation that is different from the interface orientation to which display 308 is locked. For example, if display 308 is locked to a landscape orientation and if the primary orientation of display 308 is a portrait orientation, computing device 310 may output the home screen of computing device 310 for display at display 308 in the portrait orientation, even if computing device 310 may be operable to output the home screen of computing device 310 in either the landscape orientation or the portrait orientation.

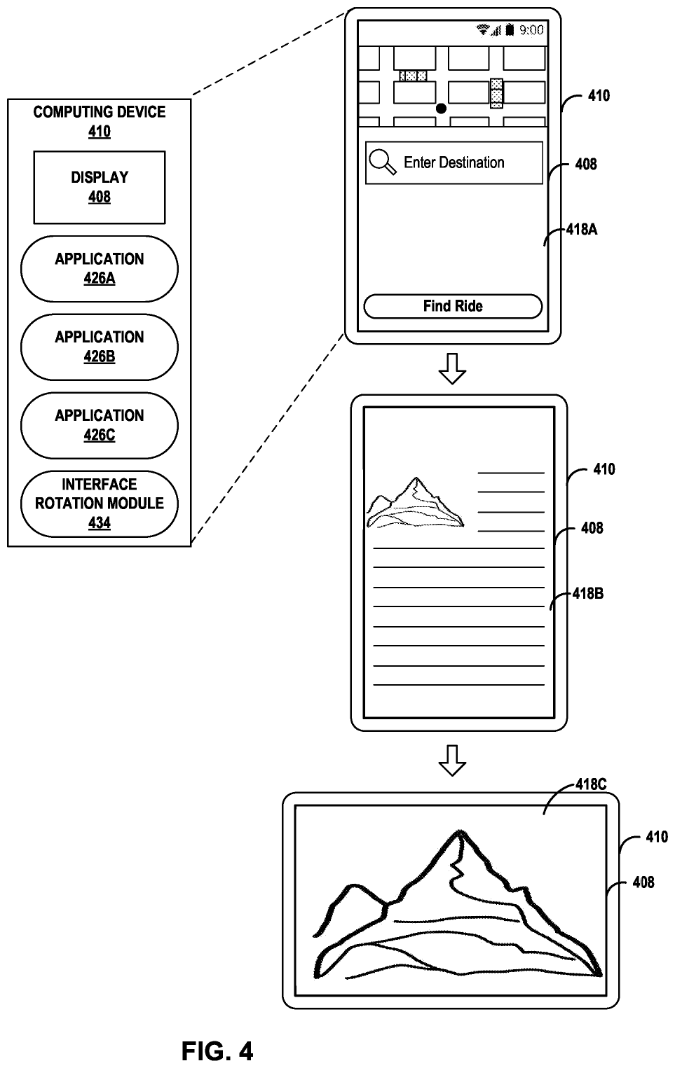

FIG. 4 is a conceptual diagram illustrating another example of a computing device that performs adaptive user interface rotation, in accordance with one or more aspects of the present disclosure. Computing device 410 of FIG. 4 is described below as an example of computing device 110 as illustrated in FIGS. 1A-1C and computing device 210 as illustrated in FIG. 2.

In some examples, while the display of a computing device is locked to a particular interface orientation, the computing device may still be able to output user interfaces in interface orientations different from the particular interface orientation to which the display is locked. If the computing device outputs a user interface in interface orientations different from the particular interface orientation to which the display is locked, the computing device may continue to outputting user interfaces in interface orientations different from the particular interface orientation to which the display is locked until the computing device activates, as a foreground application, an application that may only be operable to output a user interface in the particular interface orientation to which the display is locked.

As shown in FIG. 4, when display 408 of computing device 410 is locked to an interface orientation, computing device 410 may, in some examples, still output a user interface for display at display 408 in an interface orientation different from the interface orientation to which display 408 is locked. That is, if display 408 is locked to a portrait orientation, computing device 410 may, in some instances, output a user interface in a landscape orientation. Similarly, if display 408 is locked to a landscape orientation, computing device 410 may, in some instances, output a user interface in a portrait orientation.

For example, if an application is not operable to output a user interface in an interface orientation to which display 408 is locked but is operable to output a user interface in another interface orientation different from the interface orientation to which display 408 is locked, computing device 410 may output the user interface of the application in an interface orientation different from the interface orientation to which display 408 is locked. In the example of FIG. 4, where display 408 is locked to a landscape orientation, computing device 410 may, in response to activating application 426A that is able to output user interface 418A in the portrait orientation but is unable to output a user interface in the landscape orientation, output user interface 418A of application 426A in the portrait orientation. As such, instead of using interface rotation module 434, which is an example of interface rotation module 134 of FIGS. 1A-1C to determine a re-oriented user interface of application 426A in the landscape orientation based on user interface 418A of application 426A in the portrait orientation, computing device 410 may instead output user interface 418A of application 426A for display at display 408 in the portrait orientation.

In some examples, computing device 410 may output the user interface of an application in an interface orientation different from the interface orientation to which display 408 is locked even if the application is operable to output a user interface in the interface orientation to which display 408 is locked. For example, computing device 410 may implement one or more neural networks to determine, based on factors such as a history of previous orientations of user interfaces of the application outputted for display at display 408, a history of whether the user provided input to cause the user interfaces of the application to be outputted in a different orientation than the orientation of the user interfaces outputted for display at display 408, and the like, to determine whether to output the user interface of an application in an interface orientation different from the interface orientation to which display 408 is locked.

For example, computing device 410 may use the one or more neural networks and the factors described above to determine that when computing device 410 outputs user interfaces of application 426A in a landscape orientation, the user is likely to provide input, such as input to unlock display 408 from the landscape orientation, that causes computing device 410 to output user interfaces of application 426A in the portrait orientation. As such, computing device 410 may use the one or more neural networks and the factors described above to, in response to determining that display 408 is locked in the landscape orientation, output user interface 418A of application 426A for display at display 408 in the portrait orientation.

In response to computing device 410 outputting user interface 418A in the portrait orientation for display at display 408, computing device 410 may determine the most recent orientation of display 408 to be the portrait orientation. That is, because display 408 is displaying user interface 418A in the portrait orientation, then the most recent orientation of display 408 is the portrait orientation.

In some examples, if the most recent orientation of display 408 is different from the interface orientation to which display 408 is locked, computing device 410 may continue to output user interfaces of applications in the most recent orientation of display 408 if those applications are also operable to output user interfaces in the most recent orientation of display 408. However, if an application is not operable to output a user interface in the most recent orientation of display 408, computing device 410 may revert to outputting the user interface of the application in the interface orientation to which display 408 is locked.

In the example of FIG. 4, after outputting user interface 418A for application 426A in the portrait orientation while display 408 is locked to the landscape orientation, computing device 410 may activate application 426B as the foreground application. If application 426B is operable to output a user interface in the most recent orientation (e.g., the portrait orientation), computing device 410 may, in response to activating application 426B as the foreground application, output user interface 418B for application 426B in the portrait orientation. In response to computing device 410 outputting user interface 418B in the portrait orientation for display at display 408, computing device 410 may determine the most recent orientation of display 408 to still be the portrait orientation.

In the example of FIG. 4, after outputting user interface 418B of application 426B in the portrait orientation while display 408 is locked to the landscape orientation, computing device 410 may activate application 426C as the foreground application. If application 426C is not operable to output a user interface in the most recent orientation (e.g., the portrait orientation) but is operable to output user interface 418C in the landscape orientation, computing device 410 may, in response to activating application 426C as the foreground application, output user interface 418C for application 426C in the landscape orientation to which display 408 is locked. In response to computing device 410 outputting user interface 418C in the landscape orientation for display at display 408, computing device 410 may determine the most recent orientation of display 408 to be the landscape orientation.

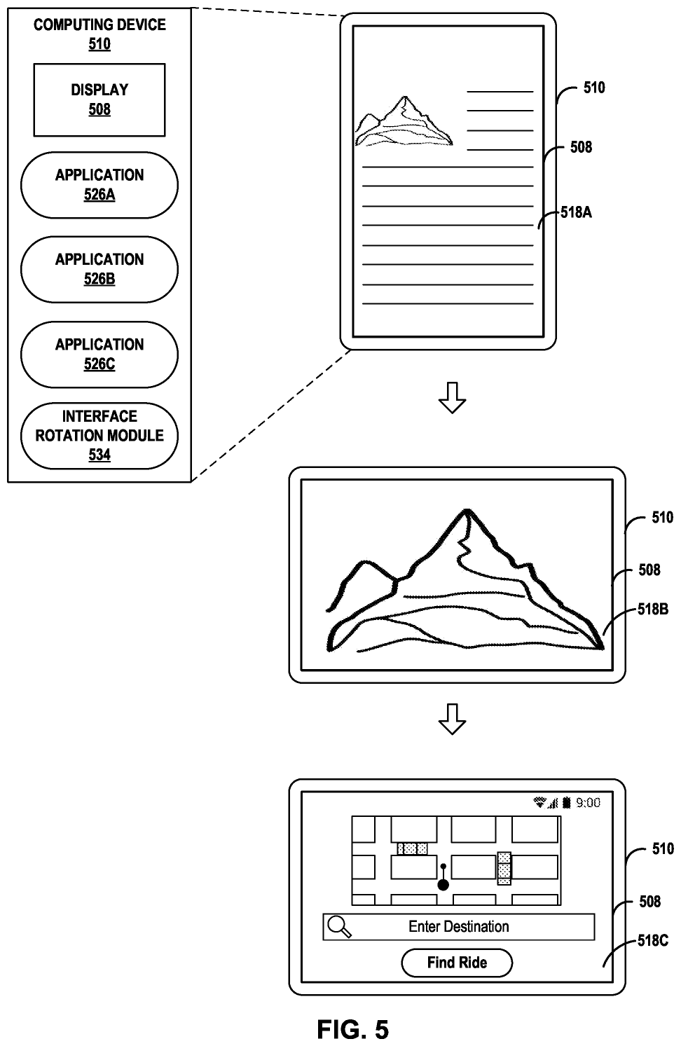

FIG. 5 is a conceptual diagram illustrating another example of a computing device that performs adaptive user interface rotation, in accordance with one or more aspects of the present disclosure. Computing device 510 of FIG. 5 is described below as an example of computing device 110 as illustrated in FIGS. 1A-1C and computing device 210 as illustrated in FIG. 2.

In some examples, computing device 510 may be able to adaptively change the interface orientation to which display 508 is locked. When display 508 is locked to a first interface orientation, computing device 510 may, based on computing device 510 outputting one or more user interfaces in a second interface orientation different from the first interface orientation to which display 508 is locked, adaptively unlock display 508 from the first interface orientation. Computing device 510 may, in some examples, adaptively lock display 508 to the second interface orientation.

In some examples, computing device 510 may adaptively change the interface orientation to which display 508 is locked based on the amount of time during which computing device 510 outputs one or more user interfaces in a second interface orientation different from the first interface orientation to which display 508 is locked. If the amount of time during which computing device 510 outputs one or more user interfaces in a second interface orientation different from the first interface orientation to which display 508 is locked exceeds a threshold amount of time, such as five minutes, ten minutes, and the like, computing device 510 may adaptively unlock display 508 from the first interface orientation. In some examples, computing device 510 may also adaptively lock display 508 to the second interface orientation, or may re-enable the autorotation function of computing device 110.

In some examples, the amount of time during which computing device 510 outputs one or more user interfaces in a second interface orientation different from the first interface orientation to which display 508 is locked may be the cumulative amount of time, since display 508 was locked to the first interface orientation, during which computing device 510 outputs one or more user interfaces in a second interface orientation. In some examples, the amount of time during which computing device 510 outputs one or more user interfaces in a second interface orientation different from the first interface orientation to which display 508 is locked may be a consecutive amount of time, since display 508 was locked to the first interface orientation, during which computing device 510 outputs one or more user interfaces in a second interface orientation. In some examples, the amount of time during which computing device 510 outputs one or more user interfaces in a second interface orientation different from the first interface orientation to which display 508 is locked may be the cumulative amount of time in a given time period (e.g., 30 minutes, one hour, etc.), since display 508 was locked to the first interface orientation, during which computing device 510 outputs one or more user interfaces in a second interface orientation.

In some examples, computing device 510 may determine whether to adaptively change the orientation to which display 508 is locked based at least in part on the type of and/or the provider of content being displayed at display 508 when such content is displayed at display 508 in an interface orientation different from the interface orientation to which display 508 is locked. For example, if display 508 is displaying media content, such as images, videos, and the like in an interface orientation different from the interface orientation to which display 508 is locked, computing device 510 may refrain from changing the orientation to which display 508 is locked. In another example, if display 508 is displaying textual content, such as web pages, text documents, and the like in an interface orientation different from the interface orientation to which display 508 is locked, computing device 510 may adaptively change the orientation to which display 508 is locked to the orientation in which the textual content is displayed at display 508.

In some examples, computing device 510 may use one or more neural networks to adaptively change the orientation to which display 508 is locked based on factors as historical patterns of usage of computing device 510, current usage of computing device 510, environmental factors (e.g., the current time of the day, the current date, etc.), the type of user interface and/or media content currently being displayed at display 508, and/or any other suitable factors. For example, computing device 510 may input data indicative of such factors to one or more neural networks, and the one or more neural network may, in response, output an indication of whether to adaptively change the interface orientation to which display 508 is locked. Computing device 510 may therefore determine, based on the output of the one or more neural networks, whether to adaptively change the interface orientation to which display 508 is locked.

In the example of FIG. 5, display 508 may be locked in a portrait orientation. While display 508 is locked in the portrait orientation, computing device 510 may output user interface 518A of a first application in a landscape orientation, which is different from the portrait orientation to which display 508 is locked. Computing device 510 may determine the amount of time during which computing device 510 outputs one or more user interfaces in the portrait orientation and may determine whether that amount of time exceeds a threshold amount of time. If computing device 510 determines that the amount of time during which computing device 510 outputs one or more user interfaces in the portrait orientation exceeds the threshold time period, computing device 510 may unlock display 508 from the portrait orientation. In some examples, computing device 510 may also lock display 508 to the landscape orientation, or may re-enable the autorotation function of computing device 510.

In some examples, computing device 510 may adaptively change the interface orientation to which display 508 is locked based on computing device 510 outputting a user interface in a primary orientation of display 508. That is, when display 508 is locked to a first interface orientation, computing device 510 may output a user interface in a second interface orientation that is different from the first interface orientation to which display 508 is locked. If the second orientation is the primary orientation of display 508, computing device 510 may adaptively unlock display 508 from the first interface orientation. In some examples, computing device 510 may also lock display 508 to the landscape orientation (i.e., the primary orientation), or may re-enable the autorotation function of computing device 510.

In the example of FIG. 5, the primary orientation of display 508 may be the landscape orientation, and display 508 may be locked in a portrait orientation. While display 508 is locked in the portrait orientation, computing device 510 may output user interface 518A of application 526A in a portrait orientation. Subsequent to outputting user interface 518A of application 526A, computing device 510 may activate application 526A as the foreground application, and may output user interface 518B of application 526B in a landscape orientation, which is different from the portrait orientation to which display 508 is locked. Computing device 510 may therefore determine that computing device 510 is outputting user interface 518B in the primary orientation of display 508. Computing device 510 may, in response to determining that computing device 510 is outputting user interface 518B in the primary orientation of display 508, unlock display 508 from the portrait orientation. In some examples, computing device 510 may also lock display 508 to the landscape orientation (i.e., the primary orientation), or may re-enable the autorotation function of computing device 510.

If computing device 510 unlocks display 508 from the portrait orientation and locks display 508 to the landscape orientation, computing device 510 may subsequently output additional user interfaces in the landscape orientation. For example, subsequent to outputting user interface 518B, computing device 510 may activate application 526C as the foreground application, and may output user interface 518C for application 526C in the landscape orientation to which display 508 is locked.

In some examples, if display 508 is locked to the landscape orientation and if application 526C is not operable to output a user interface in the landscape orientation, interface rotation module 534, which is an example of interface rotation module 134 of FIGS. 1A-1C, may determine, based on the user interface that is outputted by application 526C in a portrait orientation, user interface 518C for application 526C in the landscape orientation to which display 508 is locked, according to the techniques described throughout this disclosure. Interface rotation module 534 may therefore output user interface 518C for display at display 508 in the landscape orientation.

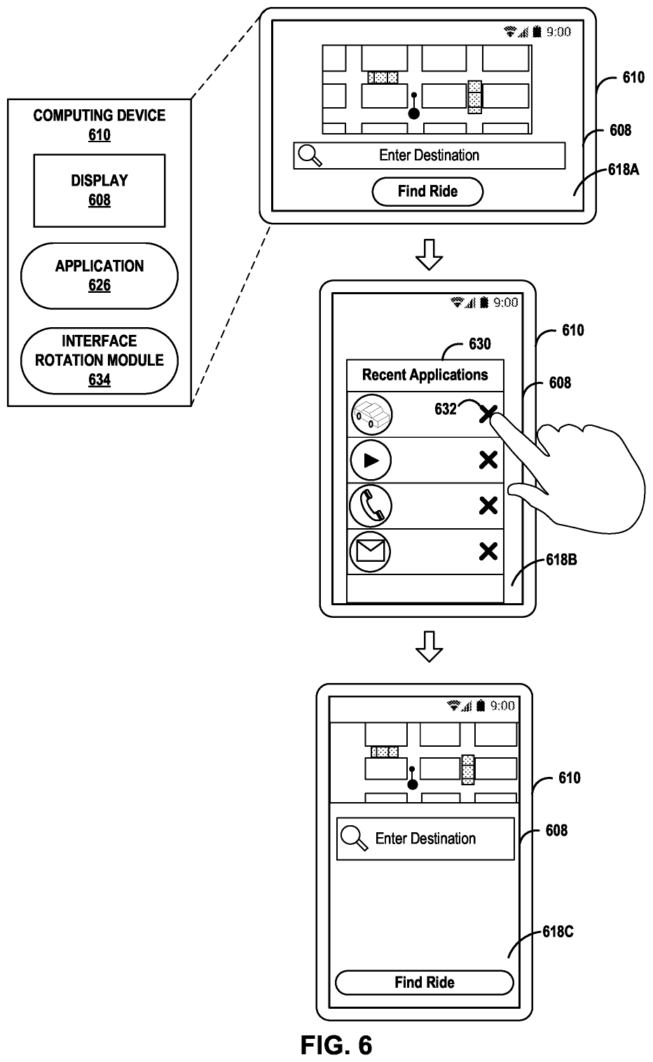

FIG. 6 is a conceptual diagram illustrating another example of a computing device that performs adaptive user interface rotation, in accordance with one or more aspects of the present disclosure. Computing device 610 of FIG. 6 is described below as an example of computing device 110 as illustrated in FIGS. 1A-1C and computing device 210 as illustrated in FIG. 2.

In some examples, each of a plurality of applications at the computing device may be associated with a respective interface orientation lock setting, so that different applications may, when activated as the foreground application, lock the display to an interface orientation specified by the interface orientation lock setting associated with the application. For example, an application that is associated with a portrait orientation may, upon being activated as a foreground application, lock the display to the portrait orientation even when the display is already locked to a landscape orientation. Similarly, an application that is associated with a landscape orientation may, upon being activated as a foreground application, lock the display to the landscape orientation even when the display is already locked to a portrait orientation.

As shown in FIG. 6, application 626 may be associated with an interface orientation lock setting that specifies display 608 is to be locked to a landscape orientation when application 626 is activated as the foreground application for computing device 610. When application 626 is activated as the foreground application for computing device 610, computing device 610 may lock display 608 to the landscape orientation specified by the interface orientation lock setting associated with application 626, regardless of whether display 608 is already locked to another interface orientation. As such, because display 608 is locked to the landscape orientation, application 626 may output user interface 618A in the landscape orientation.

In some examples, an application may be associated with an interface orientation lock setting that specifies display 608 is to be locked to a particular interface orientation even if the application is not operable to output a user interface in the particular interface orientation to which display 608 is locked. For example, even if application 626 is not operable to output a user interface in the landscape orientation, application 626 may still be associated with an interface orientation lock setting that specifies display 608 is to be locked to the landscape orientation. When application 626 outputs a user interface in the portrait orientation, interface rotation module 634, which is an example of interface rotation module 134 of FIGS. 1A-1C, may determine, based on the user interface for application 626 in the portrait orientation, a re-oriented user interface 618A for application 626 in the landscape orientation, and may output user interface 618A for display by display 608 in the landscape orientation.

In some examples, an application associated with an interface orientation lock setting may lock display 608 to the interface orientation specified by the interface orientation lock setting each time the application is activated as the foreground application. For example, if computing device 610 switches to another application as the foreground application and then subsequently re-activates application 626 as the foreground application, computing device 610 may, when application 626 is re-activated as the foreground application, lock display 608 to the portrait orientation specified by the interface orientation lock setting associated with application 626.

In some examples, when computing device 610 closes an application having an associated interface orientation lock setting, computing device 610 may clear the interface orientation lock setting associated with the application. By clearing the interface orientation lock setting associated with the application, the application may no longer be associated with an interface orientation lock setting. Thus, if the application is subsequently re-activated as the foreground application of computing device 610, the re-activation of the application may not cause computing device 610 to lock display 608 to a particular interface orientation. Instead, computing device 610 may, in some examples, re-enable the autorotation function of computing device 610.

Computing device 610 may close an application by fully quitting all of the processes of computing device 610, including any of the application's background processes. This may be in contrast to switching the foreground application of the computing device away from the application to another application, in which case the application's background processes may continue to execute at computing device 610.

In the example of FIG. 6, after application 626 is activated as the foreground application of computing device 610 and outputs user interface 618A, the user of computing device 610 may provide user input that causes computing device 610 to switch to the home screen of computing device 610 and to output user interface 618B of the home screen. While in the home screen, the user may provide user input to bring up a list of recent applications, such as recent applications list 630 in user interface 618B. The user may interact with recent applications list 630 to cause computing device 610 to close application 626, such as by selecting the close button 632 in recent applications list 630 that is associated with application 626. Computing device 610 may, in response to receiving the user input that corresponds to the selection of close button 632, close application 626.

Computing device 610 may, by closing application 626, quit all of the processes of application 626 executing at computing device 610, including any background processes of application 626. Computing device 610 may also, in response to closing application 626, clear the interface orientation lock setting associated with the application, such that application 626 is no longer associated with the interface orientation lock setting that specifies display 608 is to be locked to the landscape orientation when application 626 is activated as the foreground application.

When application 626 is subsequently re-activated as the foreground application of computing device 610, application 626 is no longer associated with the interface orientation lock setting that specifies display 608 is to be locked to the landscape orientation when application 626 is activated as the foreground application. As such, application 626 may be able to output user interface 618C in a portrait orientation at display 608.

In some examples, a computing device may output user interfaces and/or user interface elements in an interface orientation different from the particular interface orientation to which a display is locked when the user interfaces and/or user interface elements are used by users of the computing device to provide user input. The computing device may determine the interface orientation in which to output user interfaces and/or user interface elements used by users to provide user input in order to improve user comfort while providing user input via the user interfaces and/or user interface elements and/or to otherwise improve the user experience providing user input via the user interfaces and/or user interface elements.

For example, due to factors such as the form factor of the computing device, the size of the display of the computing device, and the like, it may be more comfortable for the user of a computing device to input text using a virtual keyboard that is outputted in a portrait orientation instead of a virtual keyboard that is outputted in a landscape orientation. As such, in some examples, while the display of a computing device is locked to the landscape orientation, the computing device may still output a virtual keyboard in the portrait orientation.

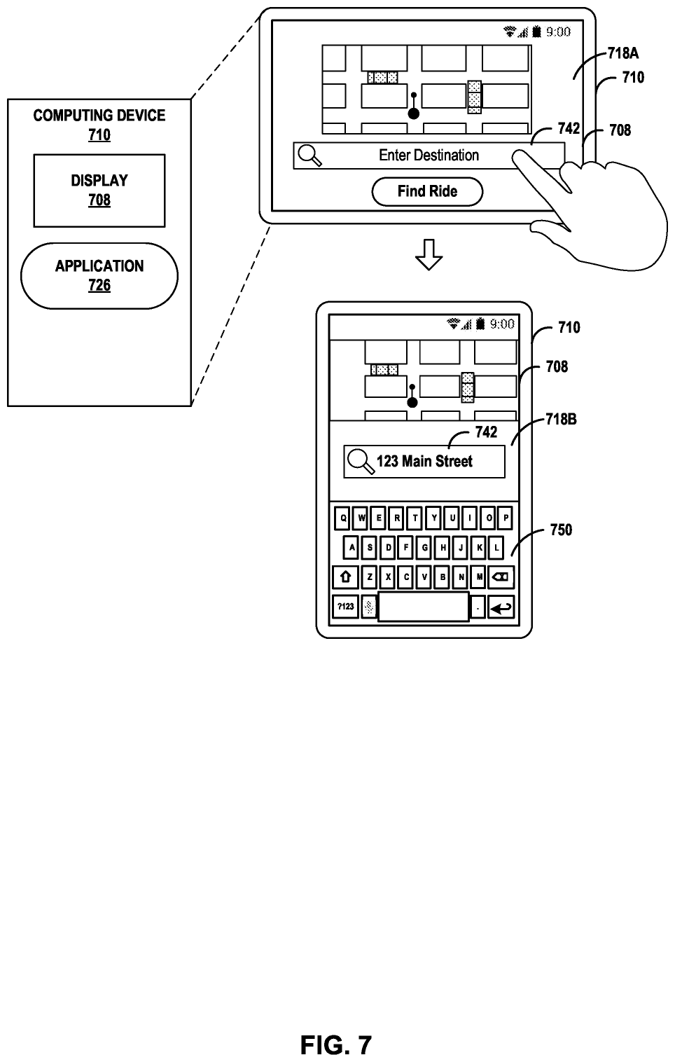

FIG. 7 is a conceptual diagram illustrating another example of a computing device that performs adaptive user interface rotation, in accordance with one or more aspects of the present disclosure. Computing device 710 of FIG. 7 is described below as an example of computing device 110 as illustrated in FIGS. 1A-1C and computing device 210 as illustrated in FIG. 2.

As shown in FIG. 7, display 708 may be locked to the landscape orientation, and application 726 executing at computing device 710 may correspondingly output user interface 718A in the landscape orientation. User interface 718A outputted by application 726 may include text field 742, which may be a user interface element that may accept text input.

The user may provide user input that corresponds to the selection of text field 742, such as by providing touch input to tap text field 742, in order to provide text input in text field 742. Computing device 710 may, in response to receiving the user input that corresponds to the selection of text field 742 output, at display 708, a virtual keyboard with which the user may interact to provide text input at text field 742.

Even though display 708 is locked to the landscape orientation, computing device 710 may output a virtual keyboard in the portrait orientation. As such, in response to computing device 710 receiving the user input that corresponds to the selection of text field 742 in user interface 718A, application 726 may output user interface 718B in the portrait orientation, where user interface 718B includes virtual keyboard 750 that is also in the portrait orientation. The user may therefore type using virtual keyboard 750 to provide text input to text field 742 in user interface 718B.

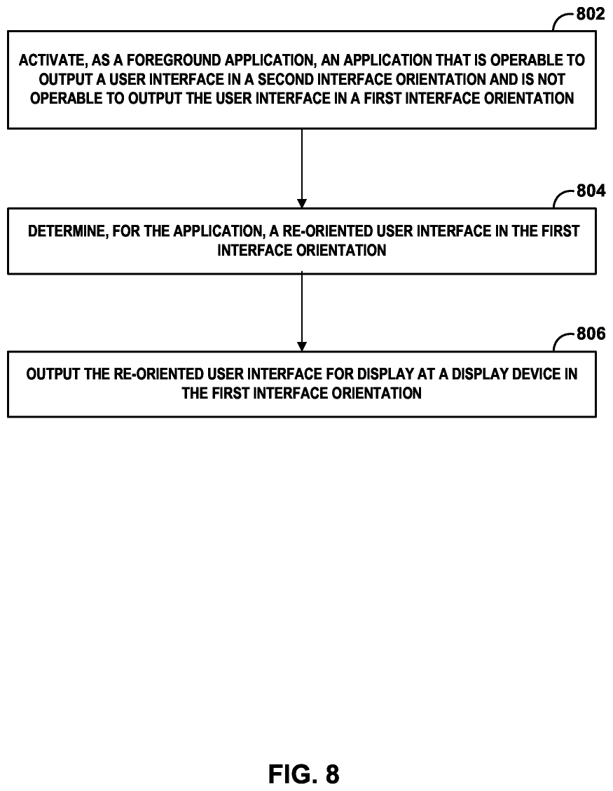

FIG. 8 is a flowchart illustrating example operations performed by an example computing device, in accordance with one or more aspects of the present disclosure. FIG. 7 is described below in the context of computing device 210 of FIG. 2.

As shown in FIG. 8, one or more processors 240 of computing device 210 may activate an application that is operable to output a user interface in a second interface orientation and is not operable to output the user interface in a first interface orientation (802). One or more processors 240 may determine, for the application, a re-oriented user interface in the first interface orientation (804). One or more processors 240 may output the re-oriented user interface for display at a display device 208 in the first interface orientation (806).

In some examples, one or more processors 240 may activate, as the foreground application, a second application that outputs a media content, where the second application is operable to output the media content in the second interface orientation and is not operable to output the media content in the first interface orientation. One or more processors 240 may, based on the display device being locked to the first interface orientation, transform the media content to generate a transformed media content for display in the first interface orientation. One or more processors 240 may output the transformed media content for display at the display device 208 in the first interface orientation.

In some examples, to transform the media content to generate the transformed media content, one or more processors 240 may perform at least one of rotating the media content or scaling the media content to generate the transformed media content for display in the first interface orientation. In some examples, the media content is a video.

In some examples, one or more processors 240 may, while the display device 208 is locked to the first interface orientation, transition the computing device 210 to a sleep state. One or more processors 240 may, in response to transitioning the computing device 210 from the sleep state to an awake state, unlock the display device 208 from the first interface orientation.

In some examples, to lock the display device 208 to the first interface orientation of the plurality of interfaces, one or more processors 240 may determine a respective interface orientation lock setting for each of a plurality of applications, the plurality of applications including the application. One or more processors 240 may, in response to the application being activated as the foreground application, lock the display device 210 to the first interface orientation specified by the respective interface orientation lock setting for the application.

In some examples, one or more processors 240 may activate, as the foreground application, a third application, wherein the third application is operable to output a third user interface in the second interface orientation and is not operable to output the third user interface in the first interface orientation. One or more processors 240 may, while the display device 208 is locked to the first interface orientation, output the third user interface for display at the display device 208 in the second interface orientation. One or more processors 240 may, based on the third user interface being outputted in the second interface orientation that is different from the first interface orientation to which the display device 208 is locked, determine a most recent interface orientation to be the second interface orientation. One or more processors 240 may, after outputting the third user interface, activate, as the foreground application, a fourth application, wherein the fourth application is operable to output a fourth user interface in the first interface orientation and is also operable to output the fourth user interface in the second interface orientation. One or more processors 240 may, while the display device 208 is locked to the first interface orientation, output, based at least in part on the most recent interface orientation being the second interface orientation, the fourth user interface for display at the display device 208 in the second interface orientation.

In some examples, one or more processors 240 may, while the display device is locked to the first interface orientation, determine an amount of time during which one or more user interfaces are outputted in the second interface orientation. One or more processors 240 may, in response to determining that the amount of time during which the one or more user interfaces are outputted in the second interface orientation exceeds a threshold amount of time, unlock the display device 208 from the first interface orientation.

In some examples, one or more processors 240 may determine that the second interface orientation is a primary orientation for the display device 208. One or more processors 240 may activate, as the foreground application, a fifth application, where the fifth application is operable to output a fifth user interface in the second interface orientation and is not operable to output the fifth user interface in the first interface orientation. One or more processors 240 may, while the display device 208 is locked to the first interface orientation, output the fifth user interface for display at the display device 208 in the second interface orientation. One or more processors 240 may, in response to outputting the fifth user interface in the second interface orientation and based at least in part on the second interface orientation being the primary orientation for the display device 208, unlock the display device 208 from the first interface orientation.

In some examples, to unlock the display device 208 from the first interface orientation, one or more processors 240 may lock the display device to the primary orientation.

In some examples, one or more processors 240 may, while the display device 208 is locked to the first interface orientation, activate a home screen, wherein the home screen is operable to output a home screen interface in the first interface orientation and is operable to output the home screen interface in the second interface orientation. One or more processors 240 may, in response to activating the home screen, output the home screen interface for display at the display device 208 in the second interface orientation.

In some examples, the first interface orientation is a portrait orientation and the second interface orientation is a landscape orientation, or the first interface orientation is the landscape orientation and the second interface orientation is the portrait orientation.

Aspects of this disclosure include the following examples.
Example 1: A method includes activating, by one or more processors, an application that is operable to output a user interface in a second interface orientation and is not operable to output the user interface in a first interface orientation; determining, by the one or more processors and for the application, a re-oriented user interface in the first interface orientation; and outputting, by the one or more processors, the re-oriented user interface for display at a display device in the first interface orientation.
Example 2: The method of example 1, further includes locking, by the one or more processors of the computing device operable to perform autorotation of interfaces to be outputted by the display device, the display device to the first interface orientation of a plurality of interface orientations;
Example 3: The method of any of examples 1 and 2, further includes activating, by the one or more processors as a foreground application, a second application that outputs a media content, wherein the second application is operable to output the media content in the second interface orientation and is not operable to output the media content in the first interface orientation; based on the display device being locked to the first interface orientation, transforming, by the one or more processors, the media content to generate a transformed media content for display in the first interface orientation; and outputting, by the one or more processors, the transformed media content for display at the display device in the first interface orientation.
Example 4: The method of example 3, wherein transforming the media content to generate the transformed media content further comprises: performing, by the one or more processors, at least one of rotating the media content or scaling the media content to generate the transformed media content for display in the first interface orientation.
Example 5: The method of any of examples 3 and 4, wherein the media content is a video.
Example 6: The method of any of examples 1-5, further includes while the display device is locked to the first interface orientation, transitioning, by the one or more processors, the computing device to a sleep state; and in response to transitioning the computing device from the sleep state to an awake state, unlocking, by the one or more processors, the display device from the first interface orientation.
Example 7: The method of any of examples 1-6, wherein locking the display device to the first interface orientation of the plurality of interface orientations further comprises: determining, by the one or more processors, a respective interface orientation lock setting for each of a plurality of applications, the plurality of applications including the application; and in response to the application being activated as the foreground application, locking, by the one or more processors, the display device to the first interface orientation specified by the respective interface orientation lock setting for the application.
Example 8: The method of any of examples 1-7, further includes activating, by the one or more processors as the foreground application, a third application, wherein the third application is operable to output a third user interface in the second interface orientation and is not operable to output the third user interface in the first interface orientation; while the display device is locked to the first interface orientation, outputting, by the one or more processors, the third user interface for display at the display device in the second interface orientation; based on the third user interface being outputted in the second interface orientation that is different from the first interface orientation to which the display device is locked, determining, by the one or more processors, a most recent interface orientation to be the second interface orientation; after outputting the third user interface, activating, by the one or more processors as the foreground application, a fourth application, wherein the fourth application is operable to output a fourth user interface in the first interface orientation and is also operable to output the fourth user interface in the second interface orientation; and while the display device is locked to the first interface orientation, outputting, by the one or more processors and based at least in part on the most recent interface orientation being the second interface orientation, the fourth user interface for display at the display device in the second interface orientation.
Example 9: The method of any of examples 1-8, further includes while the display device is locked to the first interface orientation, determining, by the one or more processors, an amount of time during which one or more user interfaces are outputted in the second interface orientation; and in response to determining that the amount of time during which the one or more user interfaces are outputted in the second interface orientation exceeds a threshold amount of time, unlocking, by the one or more processors, the display device from the first interface orientation.
Example 10: The method of any of examples 1-9, further includes determining, by the one or more processors, that the second interface orientation is a primary orientation for the display device; activating, by the one or more processors as the foreground application, a fifth application, wherein the fifth application is operable to output a fifth user interface in the second interface orientation and is not operable to output the fifth user interface in the first interface orientation; while the display device is locked to the first interface orientation, outputting, by the one or more processors, the fifth user interface for display at the display device in the second interface orientation; and in response to outputting the fifth user interface in the second interface orientation and based at least in part on the second interface orientation being the primary orientation for the display device, unlocking, by the one or more processors, the display device from the first interface orientation.
Example 11: The method of example 10, wherein unlocking the display device from the first interface orientation further comprises: locking, by the one or more processors, the display device to the primary orientation.
Example 12: The method of any of examples 1-11, further includes while the display device is locked to the first interface orientation, activating, by the one or more processors, a home screen, wherein the home screen is operable to output a home screen interface in the first interface orientation and is operable to output the home screen interface in the second interface orientation; and in response to activating the home screen, outputting, by the one or more processors, the home screen interface for display at the display device in the second interface orientation.
Example 13: The method of any of examples 1-12, wherein one of: the first interface orientation is a portrait orientation and the second interface orientation is a landscape orientation or the first interface orientation is the landscape orientation and the second interface orientation is the portrait orientation.
Example 14: A computing device includes a memory storing instructions; and one or more processors that execute the instructions to: activate an application that is operable to output a user interface in a second interface orientation and is not operable to output the user interface in a first interface orientation; determine, for the application, a re-oriented user interface in the first interface orientation; and output the re-oriented user interface for display at a display device in the first interface orientation.
Example 15: The computing device of example 14, wherein the one or more processors are operable to perform autorotation of interfaces to be outputted by the display device, and wherein the one or more processors further execute the instructions to lock the display device to the first interface orientation of a plurality of interface orientations.
Example 16: The computing device of examples 14 and 15, wherein the one or more processors further execute the instructions to: activate, as the foreground application, a second application that outputs a media content, wherein the second application is operable to output the media content in the second interface orientation and is not operable to output the media content in the first interface orientation; based on the display device being locked to the first interface orientation, transform the media content to generate a transformed media content for display in the first interface orientation; and output the transformed media content for display at the display device in the first interface orientation.
Example 17: The computing device of example 16, wherein the one or more processors that execute the instructions to transform the media content to generate the transformed media content further execute the instructions to: perform at least one of rotating the media content or scaling the media content to generate the transformed media content for display in the first interface orientation.
Example 18: The computing device of any of examples 16 and 17, wherein the media content is a video.
Example 19: The computing device of any of examples 14-18, wherein the one or more processors further execute the instructions to: while the display device is locked to the first interface orientation, transition the computing device to a sleep state; and in response to transitioning the computing device from the sleep state to an awake state, unlock the display device from the first interface orientation.
Example 20: The computing device of any of examples 14-19, wherein the one or more processors that execute the instructions to lock the display device to the first interface orientation of the plurality of interface orientations further execute the instructions to: determine a respective interface orientation lock setting for each of a plurality of applications, the plurality of applications including the application; and in response to the application being activated as the foreground application, lock the display device to the first interface orientation specified by the respective interface orientation lock setting for the application.
Example 21: The computing device of any of examples 14-20, wherein the one or more processors further execute the instructions to: activate, as the foreground application, a third application, wherein the third application is operable to output a third user interface in the second interface orientation and is not operable to output the third user interface in the first interface orientation; while the display device is locked to the first interface orientation, output the third user interface for display at the display device in the second interface orientation; based on the third user interface being outputted in the second interface orientation that is different from the first interface orientation to which the display device is locked, determine a most recent interface orientation to be the second interface orientation; after outputting the third user interface, activate, as the foreground application, a fourth application, wherein the fourth application is operable to output a fourth user interface in the first interface orientation and is also operable to output the fourth user interface in the second interface orientation; and while the display device is locked to the first interface orientation, output, based at least in part on the most recent interface orientation being the second interface orientation, the fourth user interface for display at the display device in the second interface orientation.
Example 22: The computing device of any of examples 14-21, wherein the one or more processors further execute the instructions to: while the display device is locked to the first interface orientation, determine an amount of time during which one or more user interfaces are outputted in the second interface orientation; and in response to determining that the amount of time during which the one or more user interfaces are outputted in the second interface orientation exceeds a threshold amount of time, unlock the display device from the first interface orientation.
Example 23: The computing device of any of examples 14-22, wherein the one or more processors further execute the instructions to: determine that the second interface orientation is a primary orientation for the display device; activate, as the foreground application, a fifth application, wherein the fifth application is operable to output a fifth user interface in the second interface orientation and is not operable to output the fifth user interface in the first interface orientation; while the display device is locked to the first interface orientation, output the fifth user interface for display at the display device in the second interface orientation; and in response to outputting the fifth user interface in the second interface orientation and based at least in part on the second interface orientation being the primary orientation for the display device, unlock the display device from the first interface orientation.
Example 24: The computing device of example 23, wherein the one or more processors that execute the instructions to unlock the display device from the first interface orientation further execute the instructions to: lock the display device to the primary
Example 25: The computing device of any of examples 14-24, wherein the one or more processors further execute the instructions to: while the display device is locked to the first interface orientation, activate a home screen, wherein the home screen is operable to output a home screen interface in the first interface orientation and is operable to output the home screen interface in the second interface orientation; and in response to activating the home screen, output the home screen interface for display at the display device in the second interface orientation.
Example 26: The computing device of any of examples 14-25, wherein one of: the first interface orientation is a portrait orientation and the second interface orientation is a landscape orientation or the first interface orientation is the landscape orientation and the second interface orientation is the portrait orientation.
Example 27: A non-transitory computer-readable storage medium including instructions, that when executed, cause one or more processors to: activate an application that is operable to output a user interface in a second interface orientation and is not operable to output the user interface in a first interface orientation; determine a re-oriented user interface for the application in the first interface orientation; and output the re-oriented user interface for display at a display device in the first interface orientation.
Example 28: The non-transitory computer-readable storage medium of example 27, wherein the instructions, when executed, further cause the one or more processors to: lock the display device to a first interface orientation of a plurality of interface orientations.
Example 29: The non-transitory computer-readable storage medium of any of examples 27 and 28, wherein the instructions, when executed, further cause the one or more processors to: activate, as the foreground application, a second application that outputs a media content, wherein the second application is operable to output the media content in the second interface orientation and is not operable to output the media content in the first interface orientation; based on the display device being locked to the first interface orientation, transform the media content to generate a transformed media content for display in the first interface orientation; and output the transformed media content for display at the display device in the first interface orientation.
Example 30: The non-transitory computer-readable storage medium of example 29, wherein instructions that, when executed, cause the one or more processors to transform the media content to generate the transformed media content further cause the one or more processors to: perform at least one of rotating the media content or scaling the media content to generate the transformed media content for display in the first interface orientation.
Example 31: The non-transitory computer-readable storage medium of any of examples 29 and 30, wherein the media content is a video.
Example 32: The computing device of any of examples 27-31, wherein the instructions, when executed, further cause the one or more processors to: while the display device is locked to the first interface orientation, transition the computing device to a sleep state; and in response to transitioning the computing device from the sleep state to an awake state, unlock the display device from the first interface orientation.
Example 33: The non-transitory computer-readable storage medium of any of examples 27-32, wherein the instructions that, when executed, cause the one or more processors to lock the display device to the first interface orientation of the plurality of interface orientations further cause the one or more processors to: determine a respective interface orientation lock setting for each of a plurality of applications, the plurality of applications including the application; and in response to the application being activated as the foreground application, lock the display device to the first interface orientation specified by the respective interface orientation lock setting for the application.
Example 34: The non-transitory computer-readable storage medium of any of examples 27-33, wherein the instructions, when executed, further cause the one or more processors to: activate, as the foreground application, a third application, wherein the third application is operable to output a third user interface in the second interface orientation and is not operable to output the third user interface in the first interface orientation; while the display device is locked to the first interface orientation, output the third user interface for display at the display device in the second interface orientation; based on the third user interface being outputted in the second interface orientation that is different from the first interface orientation to which the display device is locked, determine a most recent interface orientation to be the second interface orientation; after outputting the third user interface, activate, as the foreground application, a fourth application, wherein the fourth application is operable to output a fourth user interface in the first interface orientation and is also operable to output the fourth user interface in the second interface orientation; and while the display device is locked to the first interface orientation, output, based at least in part on the most recent interface orientation being the second interface orientation, the fourth user interface for display at the display device in the second interface orientation.
Example 35: The non-transitory computer-readable storage medium of any of examples 27-34, wherein the instructions, when executed, further cause the one or more processors to: while the display device is locked to the first interface orientation, determine an amount of time during which one or more user interfaces are outputted in the second interface orientation; and in response to determining that the amount of time during which the one or more user interfaces are outputted in the second interface orientation exceeds a threshold amount of time, unlock the display device from the first interface orientation.
Example 36: The non-transitory computer-readable storage medium of any of examples 27-35, wherein the instructions, when executed, further cause the one or more processors to: determine that the second interface orientation is a primary orientation for the display device; activate, as the foreground application, a fifth application, wherein the fifth application is operable to output a fifth user interface in the second interface orientation and is not operable to output the fifth user interface in the first interface orientation; while the display device is locked to the first interface orientation, output the fifth user interface for display at the display device in the second interface orientation; and in response to outputting the fifth user interface in the second interface orientation and based at least in part on the second interface orientation being the primary orientation for the display device, unlock the display device from the first interface orientation.
Example 37: The non-transitory computer-readable storage medium of example 36, wherein the instructions that, when executed, cause the one or more processors to unlock the display device from the first interface orientation further cause the one or more processors to: lock the display device to the primary orientation.
Example 38: The non-transitory computer-readable storage medium of any of examples 27-37, wherein the instructions, when executed, further cause the one or more processors to while the display device is locked to the first interface orientation, activate a home screen, wherein the home screen is operable to output a home screen interface in the first interface orientation and is operable to output the home screen interface in the second interface orientation; and in response to activating the home screen, output the home screen interface for display at the display device in the second interface orientation.
Example 39: The non-transitory computer-readable storage medium of any of examples 27-38, wherein one of: the first interface orientation is a portrait orientation and the second interface orientation is a landscape orientation or the first interface orientation is the landscape orientation and the second interface orientation is the portrait orientation.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers.

Combinations of the above should also be included within the scope of a computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structures suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

Various embodiments have been described. These and other embodiments are within the scope of the following claims.

1. A method comprising:
activating, by one or more processors of a computing device, an application that is operable to output a user interface in a second interface orientation and is not operable to output the user interface in a first interface orientation;
determining, by the one or more processors and for the application, a re-oriented user interface in the first interface orientation; and
outputting, by the one or more processors, the re-oriented user interface for display at a display device in the first interface orientation.

2. The method of claim 1, further comprising:
locking, by the one or more processors of the computing device operable to perform autorotation of interfaces to be outputted by the display device, the display device to the first interface orientation of a plurality of interface orientations.

3. The method of claim 1, further comprising:
activating, by the one or more processors, a second application that outputs a media content, wherein the second application is operable to output the media content in the second interface orientation and is not operable to output the media content in the first interface orientation;
transforming, by the one or more processors, the media content to generate a transformed media content for display in the first interface orientation; and
outputting, by the one or more processors, the transformed media content for display at the display device in the first interface orientation.

4. The method of claim 3, wherein transforming the media content to generate the transformed media content further comprises:
performing, by the one or more processors, at least one of rotating the media content or scaling the media content to generate the transformed media content for display in the first interface orientation.

5. The method of claim 3, wherein the media content is a video.

6. The method of claim 1, further comprising:
while the display device is locked to the first interface orientation, transitioning, by the one or more processors, the computing device to a sleep state; and
in response to transitioning the computing device from the sleep state to an awake state, unlocking, by the one or more processors, the display device from the first interface orientation.

7. The method of claim 2, wherein locking the display device to the first interface orientation further comprises:
determining, by the one or more processors, a respective interface orientation lock setting for each of a plurality of applications, the plurality of applications including the application; and
in response to the application being activated as a foreground application, locking, by the one or more processors, the display device to the first interface orientation specified by the respective interface orientation lock setting for the application.

8. The method of claim 1, further comprising:
activating, by the one or more processors as a foreground application, a third application, wherein the third application is operable to output a third user interface in the second interface orientation and is not operable to output the third user interface in the first interface orientation;
while the display device is locked to the first interface orientation, outputting, by the one or more processors, the third user interface for display at the display device in the second interface orientation;
based on the third user interface being outputted in the second interface orientation that is different from the first interface orientation to which the display device is locked, determining, by the one or more processors, a most recent interface orientation to be the second interface orientation;
after outputting the third user interface, activating, by the one or more processors as the foreground application, a fourth application, wherein the fourth application is operable to output a fourth user interface in the first interface orientation and is also operable to output the fourth user interface in the second interface orientation; and
while the display device is locked to the first interface orientation, outputting, by the one or more processors and based at least in part on the most recent interface orientation being the second interface orientation, the fourth user interface for display at the display device in the second interface orientation.

9. The method claim 1, further comprising:
while the display device is locked to the first interface orientation, determining, by the one or more processors, an amount of time during which one or more user interfaces are outputted in the second interface orientation; and
in response to determining that the amount of time during which the one or more user interfaces are outputted in the second interface orientation exceeds a threshold amount of time, unlocking, by the one or more processors, the display device from the first interface orientation.

10. The method of claim 1, further comprising:
determining, by the one or more processors, that the second interface orientation is a primary orientation for the display device;
activating, by the one or more processors as a foreground application, a fifth application, wherein the fifth application is operable to output a fifth user interface in the second interface orientation and is not operable to output the fifth user interface in the first interface orientation;
while the display device is locked to the first interface orientation, outputting, by the one or more processors, the fifth user interface for display at the display device in the second interface orientation; and
in response to outputting the fifth user interface in the second interface orientation and based at least in part on the second interface orientation being the primary orientation for the display device, unlocking, by the one or more processors, the display device from the first interface orientation.

11. The method of claim 10, wherein unlocking the display device from the first interface orientation further comprises:
locking, by the one or more processors, the display device to the primary orientation.

12. The method of claim 1, further comprising:
while the display device is locked to the first interface orientation, activating, by the one or more processors, a home screen, wherein the home screen is operable to output a home screen interface in the first interface orientation and is operable to output the home screen interface in the second interface orientation; and
in response to activating the home screen, outputting, by the one or more processors, the home screen interface for display at the display device in the second interface orientation.

13. The method of claim 1, wherein one of:
the first interface orientation is a portrait orientation and the second interface orientation is a landscape orientation or the first interface orientation is the landscape orientation and the second interface orientation is the portrait orientation.

14. A computing device comprising:
a memory storing instructions; and
one or more processors,
wherein the instructions, when executed by the one or more processors, configure the one or more processors to:
activate, by one or more processors of the computing device, an application that is operable to output a user interface in a second interface orientation and is not operable to output the user interface in a first interface orientation;
determine, by the one or more processors and for the application, a re-oriented user interface in the first interface orientation; and
output, by the one or more processors, the re-oriented user interface for display at a display device in the first interface orientation.

15. A non-transitory computer-readable storage medium comprising instructions that, when executed, cause one or more processors of a computing device to:
activate, by one or more processors of the computing device, an application that is operable to output a user interface in a second interface orientation and is not operable to output the user interface in a first interface orientation;
determine, by the one or more processors and for the application, a re-oriented user interface in the first interface orientation; and
output, by the one or more processors, the re-oriented user interface for display at a display device in the first interface orientation.

16. The computing device of claim 14, wherein the instructions, when executed by the one or more processors, further configure the one or more processors to:
lock, by the one or more processors of the computing device operable to perform autorotation of interfaces to be outputted by the display device, the display device to the first interface orientation of a plurality of interface orientations.

17. The computing device of claim 14, wherein the instructions, when executed by the one or more processors, further configure the one or more processors to:
activate, by the one or more processors, a second application that outputs a media content, wherein the second application is operable to output the media content in the second interface orientation and is not operable to output the media content in the first interface orientation;
transform, by the one or more processors, the media content to generate a transformed media content for display in the first interface orientation; and
output, by the one or more processors, the transformed media content for display at the display device in the first interface orientation.

18. The computing device of claim 17, wherein the instructions, when executed by the one or more processors, further configure the one or more processors to:
perform, by the one or more processors, at least one of rotating the media content or scaling the media content to generate the transformed media content for display in the first interface orientation.

19. The computing device of claim 17, wherein the instructions, when executed by the one or more processors, further configure the one or more processors to:
while the display device is locked to the first interface orientation, transition, by the one or more processors, the computing device to a sleep state; and
in response to a transition of the computing device from the sleep state to an awake state, unlock, by the one or more processors, the display device from the first interface orientation.

20. The computing device of claim 16, wherein the instructions, when executed by the one or more processors, further configure the one or more processors to:
determine, by the one or more processors, a respective interface orientation lock setting for each of a plurality of applications, the plurality of applications including the application; and
in response to the application being activated as a foreground application, lock, by the one or more processors, the display device to the first interface orientation specified by the respective interface orientation lock setting for the application.
